(19) United States
(12) Patent Application Publication
(10) Pub. No.: US 2025/0313002 A1
(43) Pub. Date: Oct. 9, 2025

(54) MULTILAYER FILM

(71) Applicant: BOREALIS AG, Vienna (AT)

(72) Inventors: Jingbo WANG, Linz (AT); Friedrich BERGER, Linz (AT)

(21) Appl. No.: 18/855,697

(22) PCT Filed: Apr. 6, 2023
(86) PCT No.: PCT/EP2023/059091

§ 371 Date: Oct. 10, 2024

(30) Foreign Application Priority Data
Apr. 11, 2022 (EP) 22167539.0

(51) Int. Cl. B32B 27/32; B32B 27/08; C08L 23/06; C08L 23/0807

(52) U.S. Cl. CPC B32B 27/327; B32B 27/08; C08L 23/06; C08L 23/0815; B32B 2250/242; B32B 2270/00; B32B 2307/31; B32B 2307/414; B32B 2307/72; B32B 2307/7376; B32B 2439/70; B32B 2439/80; C08L 2203/162; C08L 2205/025; C08L 2207/062; C08L 2207/066; C08L 2314/06

(57) ABSTRACT

Multilayered film comprising at least one layer (A), being a sealing layer (SL), and one layer (B), being a skin layer (SKL) with beneficial heat sealing, hot tack and optical properties. In particular, the invention relates to a multilayer packaging film comprising at least a sealing layer (SL) based on a specific multimodal metallocene catalysed LLDPE and a layer (B) based on a multimodal high density polyethylene.

The present invention relates to multilayer films comprising at least one layer (A), being a sealing layer (SL), and one layer (B), with beneficial heat sealing, hot tack and optical properties. In particular, the invention relates to a multilayer packaging film comprising at least a sealing layer (SL) based on a specific multimodal metallocene catalysed LLDPE and a layer (B) based on a multimodal high density polyethylene.

High standards are nowadays required for packaging materials. Quite often properties are required in the packaging industry, which are conflicting. Typically, high stiffness and toughness as well as excellent sealing behavior and good optics are required in parallel. To achieve these different properties seldom pure components, but rather combinations of different polymer components are used. Two different approaches mainly are at the skilled person's disposal: (a) blends of two or more polymers to form a heterophasic structure, or (b) producing a multilayer structure with different materials providing different functions. Both of them are applied in industry, the latter being even more popular since the choice of materials is more diverse without the need to consider the demanding technical questions of complex polymer blends. With multilayer structures known in the art already multilayer films with good properties for the packaging industry are achieved. One of the classic examples is the combination of two polyethylene layers, one being a sealing layer based on a linear low density polyethylene (LLDPE) with density about 0.918 g/cm³ and another being the core layer based on a medium density polyethylene (MDPE) or a linear low density polyethylene (LLDPE) with higher density which improves the mechanics. Such kind of combination has the weakness that an acceptable stiffness/toughness balance is reached at the expense of the optical properties due to the polyethylene with higher density.

A great variety of multilayer films have also been disclosed which should solve the above problems of non-satisfactory balance of mechanical properties, especially stiffness and toughness, and processability.

For example, WO 2008/104371 discloses multilayer film laminate which comprises a multilayer film with, in the given layer order, an inner layer (A), a core layer (B) and an outer layer (C), which is laminated to a substrate.

The inner layer (A) comprises a multimodal polyethylene composition, i.e. a bimodal linear low density polyethylene (LLDPE), having a density of 940 kg/m3 or less, a molecular weight distribution Mw/Mn of at least 8 and a MFR₂ of 0.01 to 20 g/10 min when determined according to ISO 1133 (at 190° C. and 2.16 kg load).

Preferably, the LLDPE comprises an ethylene-1-hexene copolymer, ethylene-1-octene copolymer or ethylene-1-butene copolymer.

Layer (C) comprises a LLDPE, which can be an unimodal or multimodal LLDPE. Moreover, the LLDPE can be znLLDPE or the LLDPE can be obtained by polymerization using a metallocene catalyst (mLLDPE). Both mLLDPE and znLLDPE alternatives are preferable. Also preferably, layer (C) may comprise a low-density polyethylene (LDPE) homo- or copolymer composition obtained by high-pressure polymerization.

Layer (B) can comprise or consists of the same polymer composition as used in layer (A) or layer (C).

Borstar® FB2310 or Borstar® FB2230 as commercial grades of LLDPE's are given as examples as feasible multimodal LLDPE grades for at least layer (A) and, if present, for optional layer(s), such as layer (B).

Film properties, like sealing initiation temperature (SIT) or hot tack force are not mentioned at all.

WO 2006/037603 discloses a 3-layer structure, wherein the outer layers comprise LLDPE, preferably unimodal LLDPE, especially unimodal mLLDPE. The LLDPE is preferably a C2/C6-copolymer. One or both outer layers may contain LDPE.

It is further disclosed, that a specific film may comprise a first outer layer comprising a unimodal LLDPE and LDPE blend with the other outer layer being formed from multimodal LLDPE optionally combined with an LDPE component.

The core layer comprises a multimodal polyethylene component having a lower molecular weight component and a higher molecular weight component, i.e. a multimodal LLDPE.

Thus, the multimodal PE comprises a higher molecular weight component, which preferably corresponds to an ethylene copolymer and a lower molecular weight component, which corresponds to an ethylene homopolymer or copolymer. Such 3-layer films are especially suitable for producing pouches.

Film properties, like sealing initiation temperature (SIT) or hot tack force are not mentioned at all.

For packaging companies it is of utmost importance to reduce the sealing initiation temperature (SIT) of a packaging film. Even more in the view of a sustainable and circular approach, low sealing temperature, low hot tack temperature (HTT) and high hot tack force (HTF) are required. Lower SIT and higher HTF allows running the packaging lines faster and/or at lower temperatures, thus saving costs and energy.

Starting therefrom it was an objective of the present invention to provide multilayer films having a low SIT and HTT as well as a higher HTF than the multilayer films known from the prior art. In addition, it was the objective of the present invention to provide multilayer films having improved optical properties, especially reduced haze.

Another problem is the recycling of packaging material after their first use. It is much more challenging to recycle packaging films made of different materials, e.g. different plastics, than to recycle mono-material solutions. On the other hand, the use of different materials is sometimes necessary to obtain acceptable properties, like sealing properties and mechanical properties. Therefore, another objective of the present invention is the provision of a polyethylene based mono-material solution, which shows a good sealing behaviour.

The present inventors have found that a multilayer polyethylene film comprising certain carefully selected components, especially for the sealing layer and the skin layer, provides a film with low seal initiation temperature (SIT), low hot tack temperature and improved high hot tack force. The improved sealing behaviour, especially in view of higher hot tack force is achieved in combination with an improvement of optical properties, like haze.

### SUMMARY OF INVENTION

The present invention is therefore directed to a multilayered polyethylene film comprising at least a layer (A), being a sealing layer (SL), and a layer (B), being a skin layer (SKL), wherein the sealing layer (SL) comprises:
i) 30.0 wt % to 100 wt %, based on the total weight of the sealing layer (SL), of a first multimodal metallocene catalysed linear low density polyethylene (mLLDPE-1) having a density in the range of 905 to 930 kg/m³ (ISO 1183),
a MFR₂ (190° C., 2.16 kg, ISO 1133) in the range of 0.1 to 2.0 g/10 min,
a ratio of the MFR₂₁ (190° C., 21.6 kg, ISO 1133) to MFR₂ (190° C., 2.16 kg, ISO 1133), MFR₂₁/MFR₂, in the range of 22 to 70,
wherein the first multimodal metallocene catalysed linear low density polyethylene (mLLDPE-1) consists of
(i) 30.0 to 70.0 wt % of a polyethylene component (A), consisting of ethylene polymer fractions (A-1) and (A-2); and
(ii) 70.0 to 30.0 wt % of a polyethylene component (B), the amount of (A) and (B) adding up to 100.0 wt %; and
ii) 0.0 wt % to 70 wt % of an ethylene-1-octene or ethylene-1-butene plastomer having a density in the range of 860 to 910 kg/m³ (ISO 1183) and
a MFR₂ (190° C., 2.16 kg, ISO 1133) in the range of 0.5 to 10.0 g/10 min; and
wherein the skin layer (SKL) comprises:
a) 60.0 wt % to 100.0 wt %, based on the total weight of the skin layer (SKL) of a high density polyethylene (HDPE) having a density in the range of 945 to 970 kg/m³ (ISO 1183).

In an embodiment, the invention provides a multilayered polyethylene film comprising at least a layer (A), being a sealing layer (SL), a layer (B), being a skin layer (SKL), and a layer (C), being a core layer (CL), whereby the core layer (CL) is located between the sealing layer (SL) and the skin layer (SKL), wherein layer (A) and layer (B) are defined as above and the core layer (CL) comprises:
x) 50.0 wt % to 99.0 wt %, based on the total weight of the core layer (CL), of a multimodal Ziegler-Natta catalysed linear low density polyethylene (znLLDPE-1) having a density in the range of 920 to 950 kg/m³ and an MFR₅ (190° C., 5 kg, ISO 1133) in the range of from 0.1 to 4.0 g/10 min; and
y) 1.0 wt % to 50.0 wt %, based on the total weight of the core layer (CL), of a second multimodal metallocene catalysed linear low density polyethylene (mLLDPE-2) having a density in the range of 905 to 930 kg/m³ (ISO 1183) and
a MFR₂ (190° C., 2.16 kg, ISO 1133) in the range of 0.1 to 2.0 g/10 min,
the total amounts of x)+y) summing up to 100 wt %.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed linear low density polyethylene (mLLDPE) is defined in this invention as linear low density polyethylene copolymer, which has been produced in the presence of a metallocene catalyst.

Ziegler-Natta catalysed linear low density polyethylene (znLLDPE) is defined in this invention as linear low density polyethylene copolymer, which has been produced in the presence of a Ziegler-Natta catalyst.

Term “multimodal” in context of multimodal linear low density polyethylene means herein multimodality with respect to melt flow rate (MFR). The multimodal linear low density polyethylene can have further multimodality with respect to one or more further properties, like density, comonomer type and/or comonomer content, as will be described later below.

The first multimodal metallocene catalysed linear low density polyethylene (mLLDPE-1) used according to the invention as defined above, below or in claims is also referred herein shortly as mLLDPE-1.

The second multimodal metallocene catalysed linear low density polyethylene (mLLDPE-2) used according to the invention as defined above, below or in claims is also referred herein shortly as mLLDPE-2.

The multimodal Ziegler-Natta catalysed linear low density polyethylene (znLLDPE) used according to the invention as defined above, below or in claims is also referred herein shortly as znLLDPE.

The (multimodal) high density polyethylene (HDPE) used according to the invention as defined above, below or in claims is also referred herein shortly as HDPE.

For the purpose of the present invention mLLDPE, as well as znLLDPE or HDPE which consists of a component (A) and an component (B)” means that the polyethylene is produced in an at least 2-stage sequential polymerization process, wherein first component (A) is produced and component (B) is then produced in the presence of component (A) in a subsequent polymerization step, yielding the polyethylene or vice versa, i.e. first component (B) is produced and component (A) is then produced in the presence of component (B) in a subsequent polymerization step, yielding the polyethylene.

Polyethylene produced in a multistage process are also designated as “in-situ” or “reactor” blends. The resulting end product consists of an intimate mixture of the polymers from the two or more reactors, the different molecular-weight-distribution curves of these polymers together forming a molecular-weight-distribution curve having a broad maximum or two or more maxima, i.e. the end product is a multimodal polymer mixture.

### DETAILED DESCRIPTION OF INVENTION

The film of the invention is a multilayered polyethylene film comprising at least layer (A) and layer (B).

The at least two layers (A) and (B) are both composed of polyethylene polymers only, i.e. no other polymer than an ethylene based polymer is present.

In an embodiment of the invention the multilayered polyethylene film comprises at least layer (A), layer (B) and layer (C).

Also layer (C) is composed of polyethylene polymers only.

### Layer (a), Respectively Sealing Layer (SL)

Layer (A) of the multilayered film of the invention is the sealing layer (SL) and comprises
i) 30.0 wt % to 100 wt %, based on the total weight of the sealing layer (SL), of a first multimodal metallocene catalysed linear low density polyethylene (mLLDPE-1) and
ii) 0.0 wt % to 70 wt % of an ethylene-1-octene or ethylene-1-butene plastomer having a density in the range of 860 to 910 kg/m³ (ISO 1183) and a MFR₂ (190° C., 2.16 kg, ISO 1133) in the range of 0.5 to 10.0 g/10 min.

In an embodiment of the invention a low density polyethylene (LDPE) can be added as alternative polyethylene based polymer instead of the plastomer. The total amount of the LDPE is 0.0 to 30.0 wt %, based on the total weight of the sealing layer (SL), whereby the optional low density polyethylene (LDPE) has a density in the range of 910 to 940 kg/m³ (ISO1183) and a MFR₂ (ISO1133, 2.16 kg, 190° C.) in the range of from 0.05 to 2.0 g/10 min. Preferably, a plastomer is added as 2^{nd} polyethylene based polymer.

More preferably, the sealing layer (SL) consists of the first multimodal metallocene catalysed linear low density polyethylene (mLLDPE-1).

Ad First Multimodal Metallocene Catalysed Linear Low Density Polyethylene (mLLDPE-1)

The first multimodal metallocene catalysed linear low density polyethylene (mLLDPE-1) has a density (ISO 1183) in the range of 905 to 930 kg/m³, preferably in the range of 908 to 925 kg/m³ and more preferably in the range of 910 to 920 kg/m³, like 912 to 918 kg/m³.

The MFR₂ (190° C., 2.16 kg, ISO 1133) of the first multimodal metallocene catalysed linear low density polyethylene (mLLDPE-1) is in the range of 0.1 to 2.0 g/10 min, preferably 0.5 to 1.8 g/10 min, more preferably 0.8 to 1.5 g/10 min, like 0.9 to 1.3 g/10 min.

The first multimodal metallocene catalysed linear low density polyethylene (mLLDPE-1) further has a ratio of the MFR₂₁ (190° C., 21.6 kg, ISO 1133) to MFR₂ (190° C., 2.16 kg, ISO 1133), MFR₂₁/MFR₂, in the range of from 22 to 70, preferably from 25 to 50, more preferably from 28 to 35.

The first multimodal metallocene catalysed linear low density polyethylene (mLLDPE-1) is a copolymer of ethylene with at least two different comonomers selected from alpha-olefins having from 4 to 10 carbon atoms, e.g. 1-butene, 1-hexene, 1-octene, preferably 1-butene and 1-hexene.

The total amount of 1-butene, based on the multimodal metallocene catalysed linear low density polyethylene (mLLDPE-1) is preferably in the range of 0.1 to 3.0 wt %, preferably 0.2 to 2.5 wt % and more preferably 0.3 to 2.0 wt %.

The total amount of 1-hexene, based on the multimodal metallocene catalysed linear low density polyethylene (mLLDPE-1) preferably is in the range of 2.0 to 20.0 wt %, preferably 4.0 to 18.0 wt % and more preferably 6.0 to 15.0 wt %.

The first multimodal metallocene catalysed linear low density polyethylene (mLLDPE-1) of the sealing layer (SL) consists of
(i) 30.0 to 70.0 wt % of a polyethylene component (A), and
(ii) 70.0 to 30.0 wt % of a polyethylene component (B).

The amount of (A) and (B) add up to 100.0 wt %.

In addition, the polyethylene component (A) consists of ethylene polymer fractions (A-1) and (A-2).

It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably fraction (A-1) is produced first.

The multimodal metallocene catalysed linear low density polyethylene (mLLDPE-1) is referred herein as “multimodal”, since the polyethylene component (A), including ethylene polymer fractions (A-1) and (A-2), and polyethylene component (B) have been produced under different polymerization conditions resulting in different Melt Flow Rates (MFR, e.g. MFR₂). I.e. the multimodal PE is multimodal at least with respect to difference in MFR of the polyethylene components (A) and (B).

Preferably, the alpha-olefin comonomer having from 4 to 10 carbon atoms of the polyethylene component (A) is different from the alpha-olefin comonomer having from 4 to 10 carbon atoms of polyethylene component (B), more preferably the alpha-olefin comonomer having from 4 to 10 carbon atoms of polyethylene component (A) is selected from 1-butene, 1-hexene and 1-octene, more preferably is 1-butene; and the alpha-olefin comonomer having from 4 to 10 carbon atoms of polyethylene component (B) is preferably selected from 1-hexene and 1-octene, more preferably is 1-hexene.

The comonomer type for the polymer fractions (A-1) and (A-2) is the same, thus the same alpha-olefin comonomer having from 4 to 10 carbon atoms is used for fraction (A-1) and (A-2), more preferably both fractions therefore have 1-butene as comonomer.

Thus, in a preferred embodiment polyethylene component (A) is an ethylene-1-butene polymer component (A) and polyethylene component (B) is an ethylene-1-hexene polymer component (B).

The total amount (wt %) of 1-butene, present in the ethylene-1-butene polymer component (A) is of 0.5 to 8.0 wt %, preferably of 0.6 to 6.0 wt %, more preferably of 0.8 to 5.0 wt %, even more preferably of 1.0 to 4.0 wt %, based on the ethylene-1-butene polymer component (A).

The total amount (wt %) of 1-hexene, present in the ethylene-1-hexene polymer component (B) is of 8.0 to 25.0 wt %, preferably of 9.0 to 22.0 wt %, more preferably of 10.0 to 20.0 wt %, based on the ethylene-1-hexene polymer component (B).

The MFR₂ of the ethylene polymer components (A) and (B) are different from each other.

The ethylene polymer component (A) has a MFR₂ (190° C., 2.16 kg, ISO 1133) in the range of 2.0 to 400 g/10 min, preferably of 2.5 to 300 g/10 min, more preferably of 3.0 to 200 g/10 min, even more preferably of 3.2 to 100 g/10 min and still more preferably of 3.5 to 70.0 g/10 min, like 3.8 to 50.0 g/10 min.

The ethylene polymer component (B) has a MFR₂ (190° C., 2.16 kg, ISO 1133) in the range of 0.001 to 1.5 g/10 min, preferably of 0.005 to 1.0 g/10 min, more preferably of 0.01 to 0.8 g/10 min and even more preferably of 0.02 to 0.5 g/10 min.

The MFR₂ of the ethylene polymer fractions (A-1) and (A-2) may be different from each other or may be the same.

The ethylene polymer fraction (A-1) has a MFR₂ (190° C., 2.16 kg, ISO 1133) in the range of 1.0 to 800.0 g/10 min, preferably of 1.5 to 400.0 g/10 min, more preferably of 1.8 to 200.0 g/10 min and even more preferably of 2.0 to 50.0 g/10 min, like 2.1 to 40.0 g/10 min.

The ethylene polymer fraction (A-2) has a MFR₂ (190° C., 2.16 kg, ISO 1133) in the range of 2.0 to 400.0 g/10 min, preferably of 2.5 to 200.0 g/10 min, more preferably of 3.0 to 100.0 g/10 min and most preferably of 3.5 to 80.0 g/10 min.

In an embodiment of the invention it is preferred the ratio of the MFR₂ (190° C., 2.16 kg, ISO 1133) of ethylene-1-butene polymer component (A) to the MFR₂ (190° C., 2.16 kg, ISO 1133) of the final multimodal metallocene catalysed linear low density polyethylene (mLLDPE) is at least 3.0 to 120.0, preferably 3.5 to 100.0 and more preferably of 4.0 to 90.0.

The density of the ethylene polymer component (A) is in the range of 920 to 950 kg/m³, preferably of 925 to 948 kg/m³, more preferably of 930 to 945 kg/m³ and/or the density of the ethylene polymer component (B) is of in the range of 885 to 918 kg/m³, preferably of 888 to 915 kg/m³ and more preferably of 890 to 912 kg/m³.

The density of the ethylene polymer fractions (A-1) and (A-2) may be different from each other or may be the same.

The polymer fraction (A-1) has a density in the range of 920 to 950 kg/m³, preferably of 925 to 948 kg/m³, more preferably of 930 to 946 kg/m³, like 935 to 945 kg/m³.

The density of the polymer fraction (A-2) is in the range of 920 to 950 kg/m³, preferably of 925 to 945 kg/m³.

It is within the scope of the invention, that the first and the second ethylene polymer fraction (A-1 and A-2) of the polyethylene component (A) are present in a weight ratio of 4:1 up to 1:4, such as 3:1 to 1:3, or 2:1 to 1:2, or 1:1.

The polyethylene component (A) is present in an amount of 30.0 to 70.0 wt % based on the multimodal metallocene catalysed linear low density polyethylene (mLLDPE-1), preferably in an amount of 32.0 to 55.0 wt % and even more preferably in an amount of 34.0 to 45.0 wt %. Thus, the polyethylene component (B) is present in an amount of 70.0 to 30.0 wt % based on the multimodal metallocene catalysed linear low density polyethylene (mLLDPE-1), preferably in an amount of 68.0 to 45.0 wt % and more preferably in an amount of 66.0 to 55.0 wt %.

Since the polyethylene component (A) of the multimodal metallocene catalysed linear low density polyethylene (mLLDPE-1) consists of ethylene polymer fractions (A-1) and (A-2), the multimodal metallocene catalysed linear low density polyethylene (mLLDPE-1) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably fraction (A-1) is produced first.

The loop reactor 2 is thereby connected in series to a gas phase reactor (GPR), so that the first polyethylene component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273, WO 2021009189, WO 2021009190, WO 2021009191 and WO 2021009192. Full details of how to prepare suitable multimodal metallocene catalysed linear low density polyethylene (mLLDPE-1) can be found in these references.

A suitable process is the Borstar PE process or the Borstar PE 3G process.

The multimodal metallocene catalysed linear low density polyethylene (mLLDPE-1) according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of polyethylene component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal metallocene catalysed linear low density polyethylene (mLLDPE-1). This can counted as part of the first polyethylene component (A).

### Catalyst

The mLLDPE-1 used according to the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

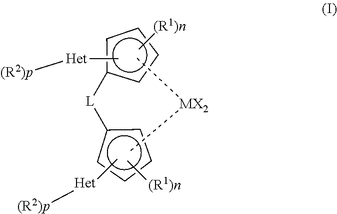

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure

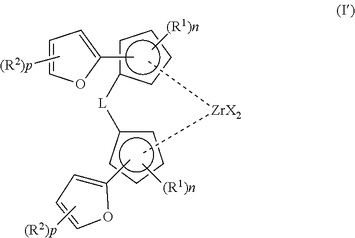

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) are

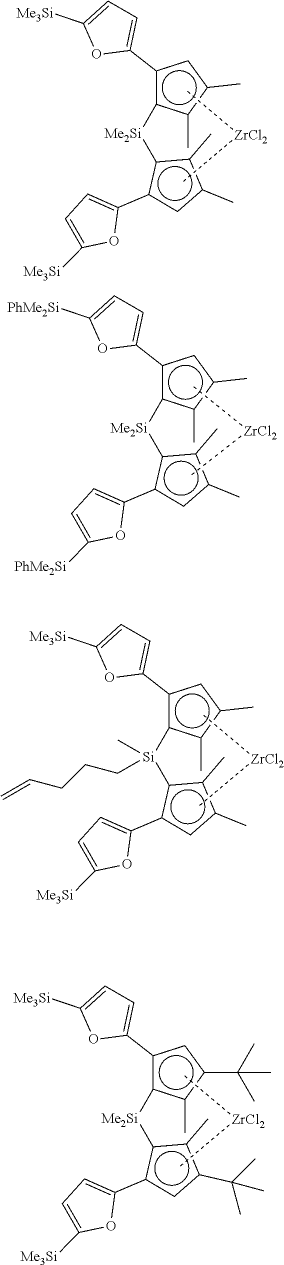

Most preferably the complex dimethylsilanediylbis[2-(5-trimethylsilylfuran-2-yl)-4,5-dimethylcyclopentadien-1-yl]zirconium dichloride is used.

More preferably the polyethylene components (A) and (B) of the mLLDPE-1 are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The mLLDPE-1 may optional contain additives and/or fillers.

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

### Ad Ethylene-1-Octene or Ethylene-1-Butene Plastomer

The sealing layer (SL) may contain as additional polyethylene based polymer an ethylene-1-octene or ethylene-1-butene plastomer in an amount of 0.0 wt % to 70.0 wt %.

In case a plastomer is added as additional polyethylene based polymer, the amount of plastomer is in the range of 20.0 wt % to 65.0 wt %, preferably 30.0 to 60.0 wt %, based on the total weight of the sealing layer (SL).

The ethylene-1-octene or ethylene-1-butene plastomer has a density (ISO1183) in the range of 860 to 910 kg/m³, preferably of 870 to 908 kg/m³, more preferably 880 to 905 kg/m³.

The MFR₂ (190° C., 2.16 kg, ISO 1133) of the plastomer is in the range of 0.5 to 10.0 g/10 min, preferably 0.8 to 8.0 g/10 min, more preferably 0.9 to 5.0 g/10 min, like 0.9 to 3.5 g/10 min.

Preferred plastomers are ethylene-1-octene plastomers.

The content of comonomer, such as 1-octene, in the plastomer may be in the range of 5.0 to 40.0 wt %, such as 12.0 to 30.0 wt %.

The molecular mass distribution Mw/Mn of suitable plastomers is most often below 4, such as 3.8 or below, but is at least 2.0. It is preferably between 3.7 and 2.1.

Suitable ethylene-1-butene or ethylene-1-octene plastomers can be any copolymer of ethylene and 1-butene or 1-octene having the above defined properties, which are commercial available, i.a. from Borealis under the tradename Queo, like e.g. Queo 8201 or Queo 0201, from DOW Chemical Corp (USA) under the tradename Engage or Affinity, or from Mitsui Chemicals under the tradename Tafmer.

Alternatively, these plastomers can be prepared by known processes, in a one stage or two stage polymerization process, comprising solution polymerization, slurry polymerization, gas phase polymerization or combinations therefrom, in the presence of suitable catalysts, like vanadium oxide catalysts or single-site catalysts, e.g. metallocene or constrained geometry catalysts, known to the art skilled persons. Plastomers of the invention are ideally formed using metallocene type catalysts.

Preferably, these plastomers are prepared by a one stage or two stage solution polymerization process, especially by high temperature solution polymerization process at temperatures higher than 100° C.

Such process is essentially based on polymerizing the monomer and a suitable comonomer in a liquid hydrocarbon solvent in which the resulting polymer is soluble. The polymerization is carried out at a temperature above the melting point of the polymer, as a result of which a polymer solution is obtained. This solution is flashed in order to separate the polymer from the unreacted monomer and the solvent. The solvent is then recovered and recycled in the process.

Preferably, the solution polymerization process is a high temperature solution polymerization process, using a polymerization temperature of higher than 100° C. More preferably the polymerization temperature is at least 110° C., more preferably at least 150° C. The polymerization temperature can be up to 250° C.

The pressure in such a solution polymerization process is preferably in a range of 10 to 100 bar, preferably 15 to 100 bar and more preferably 20 to 100 bar. The liquid hydrocarbon solvent used is preferably a C5-12-hydrocarbon which may be unsubstituted or substituted by C1-4 alkyl group such as pentane, methyl pentane, hexane, heptane, octane, cyclohexane, methylcyclohexane and hydrogenated naphtha. More preferably unsubstituted C6-10-hydrocarbon solvents are used.

A known solution technology suitable for the process according to the invention is the Borceed™ technology.

Ad low density polyethylene (LDPE) Instead of a plastomer, the sealing layer (SL) may contain as additional polyethylene based polymer a low density polyethylene (LDPE) in an amount of 0.0 wt % to 30.0 wt %.

In case a LDPE is added as additional polyethylene based polymer, tha amount of LDPE added is in the range of 5.0 wt % to 30.0 wt %, preferably 15.0 to 25.0 wt %, based on the total weight of the sealing layer (SL).

The optional LDPE has a density in the range of 910 to 940 kg/m³ (ISO1183) and a MFR₂ (ISO1133, 2.16 kg, 190° C.) in the range of from 0.05 to 2.0 g/10 min.

The low density polyethylene (LDPE) is preferably a low density polyethylene produced in a high pressure process.

Such LDPEs are well known in the art and they typically contain long chain branching which differentiates LDPEs from linear low-density polyethylenes, LLDPEs.

The LDPE preferably has a density (ISO1183) in the range of 912 to 938 kg/m³, more preferably in the range of 914 to 935 kg/m³, still more preferably in the range of 915 to 925 kg/m³.

Further it is preferred that the LDPE has a melt flow rate MFR₂ (ISO1133, 2.16 kg, 190° C.) in the range of from 0.08 to 1.9 g/10 min, more preferably in the range of from 0.10 to 1.8 g/10 min, and even more preferably in the range of from 0.15 to 1.5 g/10 min.

The Tm (DSC, ISO 11357-3) of the LDPE is preferably in the range of 70-180° C., more preferably 90-140° C., e.g. about 110-120° C.

LDPEs suitable for layer (A) are any conventional LDPEs, e.g. commercially known LDPEs, or they may be prepared according to any conventional high-pressure polymerization (HP) process in a tubular or autoclave reactor using a free radical formation. Such HP processes are very well known in the field of polymer chemistry.

Typical pressures are from 1000 to 3000 bar. The polymerization temperature is preferably in the range of 150-350° C. The free radical initiators are commonly known, e.g. organic peroxide based initiators.

Suitable LDPE's are available commercially from Borealis, Basell, Exxon, Sabic, or other suppliers.

### Layer (B), Respectively Skin Layer (SKL)

Layer (B) is the skin layer (SKL) of the multilayered film and comprises:
a) 60.0 wt % to 100.0 wt %, based on the total weight of the skin layer (SKL) of a multimodal high density polyethylene (HDPE) having a density in the range of 945 to 970 kg/m³ (ISO 1183), a MFR₂ (190° C., 2.16 kg, ISO 1133) in the range of 0.1 to 2.0 g/10 min.

As additional polymer in a total amount of 0.0 to 40.0 wt %, based on the total weight of the skin layer (SKL), preferably 5.0 wt % to 30.0 wt %, more preferably 10.0 wt % to 25.0 wt % of an ethylene-1-octene or ethylene-1-butene plastomer having a density in the range of 860 to 910 kg/m³ (ISO1183) and a MFR₂ (190° C., 2.16 kg, ISO 1133) in the range of 0.5 to 10.0 g/10 min and/or a linear low density polyethylene (LLDPE) having a density in the range of 910 to 945 kg/m³ (ISO1183) and a MFR₂ (ISO1133, 2.16 kg, 190° C.) in the range of from 0.1 to 2.0 g/10 min can be added.

Suitable plastomers are as described above for Layer (A).

Suitable LLDPEs are e.g. znLLDPEs as described below for the core layer (CL), or metallocene catalysed linear low density polyethylenes as e.g. described for the sealing layer (SL) or the core layer (CL) or commercial available mLLDPEs like FK1820 (Borealis or Borouge), or Supertough grades from Total (e.g. 40ST05 or 22ST05).

Preferably, the skin layer (SKL) consists of the high density polyethylene (HDPE).

### Ad High Density Polyethylene (HDPE)

The high density polyethylene (HDPE) has a density in the range of 945 to 970 kg/m³ (ISO 1183), preferably 948 to 968 kg/m³ and more preferably 950 to 965 kg/m³, like 951 to 962 kg/m³.

The MFR₂ (190° C., 2.16 kg, ISO 1133) of the HDPE is in the range of 0.1 to 3.0 g/10 min, preferably 0.2 to 2.5 g/10 min, more preferably 0.5 to 2.0 g/10 min.

The MFR₅ (190° C., 5 kg, ISO 1133) of the HDPE may be in the range of 1.0 to 10.0 g/10 min, preferably 1.5 to 8.0 g/10 min, more preferably 2.0 to 6.0 g/10 min.

The MFR₂₁ (190° C., 21.6 kg, ISO 1133) of the HDPE may be in the range of 20.0 to 100.0 g/10 min, preferably 25.0 to 80.0 g/10 min, more preferably 30.0 to 60.0 g/10 min.

The HDPE may have a (melt) flow rate ratio FRR21/5 (MFR₂₁/MFR₅) of from 5 to 30, preferably from 7 to 25 and most preferably from 8 to 20.

The HDPE may further have a melting temperature (Tm) of in the range of 128° to 140° C., preferably 1290 to 135° C.

The HDPE can be produced either with a metallocene catalyst system or with a Ziegler-Natta catalyst system.

### Ad Metallocene Catalyst System

As metallocene catalyst system, the catalyst system as described above for the mLLDPE-1 can be used.

Alternatively, a metallocene complex of formula (II) can be used.

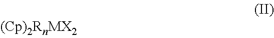

wherein:
each Cp independently is an unsubstituted or substituted and/or fused cyclopentadienyl ligand, e.g. substituted or unsubstituted cyclopentadienyl, substituted or unsubstituted indenyl or substituted or unsubstituted fluorenyl ligand;
the optional one or more substituent(s) being independently selected preferably from halogen, hydrocarbyl (e.g. C₁-C₂₀-alkyl, C₂-C₂₀-alkenyl, C₂-C₂₀-alkynyl, C₃-C₁₂-cycloalkyl, C₆-C₂₀-aryl or C₇-C₂₀-arylalkyl), C₃-C₁₂-cycloalkyl which contains 1, 2, 3 or 4 heteroatom(s) in the ring moiety, C₆-C₂₀-heteroaryl, C₁-C₂₀-haloalkyl, —SiR″₃, —OSiR″₃, —SR″, —PR″₂, OR″ or —NR″₂,
each R″ is independently a hydrogen or hydrocarbyl, e.g. C₁-C₂₀-alkyl, C₂-C₂₀-alkenyl, C₂-C₂₀-alkynyl, C₃-C₁₂-cycloalkyl or C₆-C₂₀-aryl; or e.g. in case of —NR″₂, the two substituents R″ can form a ring, e.g. five- or six-membered ring, together with the nitrogen atom to which they are attached;
R is a bridge of 1-7 atoms, e.g. a bridge of 1-4 C-atoms and 0-4 heteroatoms, wherein the heteroatom(s) can be e.g. Si, Ge and/or O atom(s), wherein each of the bridge atoms may bear independently substituents, such as C₁-C₂₀-alkyl, tri(C₁-C₂₀-alkyl)silyl, tri(C₁-C₂O-alkyl)siloxy or C₆-C₂₀-aryl substituents); or a bridge of 1-3, e.g. one or two, hetero atoms, such as silicon, germanium and/or oxygen atom(s), e.g. —SiR²₂—, wherein each R² is independently C₁-C₂₀-alkyl, C₃₋₁₂-cycloalkyl, C₆-C₂₀-aryl or tri(C₁-C₂₀-alkyl)silyl- residue, such as trimethylsilyl;
M is a transition metal of Group 4, e.g. Ti, Zr or Hf, especially Zr or Hf;
each X is independently a sigma-ligand, such as H, halogen, C₁-C₂₀-alkyl, C₁-C₂₀-alkoxy, C₂-C₂₀-alkenyl, C₂-C₂₀-alkynyl, C₃-C₁₂-cycloalkyl, C₆-C₂₀-aryl, C₆-C₂₀-aryloxy, C₇-C₂₀-arylalkyl, C₇-C₂₀-arylalkenyl, —SR″, —PR″₃, —SiR″₃, —OSiR″₃, —NR″₂ or —CH₂—Y, wherein Y is C₆-C₂₀-aryl, C₆-C₂₀-heteroaryl, C₁-C₂₀-alkoxy, C₆-C₂₀-aryloxy, NR″₂, —SR″, —PR″₃, —SiR″₃, or —OSiR″₃;
each of the above mentioned ring moieties alone or as a part of another moiety as the substituent for Cp, X, R″ or R² can further be substituted e.g. with C₁-C₂₀-alkyl which may contain Si and/or O atoms;
n is 0 or 1.

Suitably, in each X as —CH₂—Y, each Y is independently selected from C₆-C₂₀-aryl, NR″₂, —SiR″₃ or —OSiR″₃. Most preferably, X as —CH₂—Y is benzyl. Each X other than —CH₂—Y is independently halogen, C₁-C₂₀-alkyl, C₁-C₂₀-alkoxy, C₆-C₂₀-aryl, C₇-C₂₀-arylalkenyl or —NR″₂ as defined above, e.g. —N(C₁-C₂₀-alkyl)₂.

Preferably, each X is halogen, methyl, phenyl or —CH₂—Y, and each Y is independently as defined above, more preferably X is halogen or methyl.

Cp is preferably cyclopentadienyl, indenyl, tetrahydroindenyl or fluorenyl, optionally substituted as defined above. More preferably Cp is a cyclopentadienyl or indenyl, even more preferably Cp is cyclopentadienyl.

In a suitable subgroup of the compounds of formula (II), each Cp independently bears 1, 2, 3 or 4 substituents as defined above, preferably 1, 2 or 3, such as 1 or 2 substituents, which are preferably selected from C₁-C₂₀-alkyl, C₆-C₂₀-aryl, C₇-C₂₀-arylalkyl (wherein the aryl ring alone or as a part of a further moiety may further be substituted as indicated above), —OSiR″₃, wherein R″ is as indicated above, preferably C₁-C₂₀-alkyl.

R, if present, is preferably a methylene, ethylene or a silyl bridge, whereby the silyl can be substituted as defined above, e.g. a (dimethyl)Si═, (methylphenyl)Si═, (methylcyclohexyl)silyl= or (trimethylsilylmethyl)Si═;
n is 0 or 1, preferably 0.

The preparation of the metallocenes can be carried out according or analogously to the methods known from the literature and is within skills of a person skilled in the field. Thus for the preparation see e.g. EP-A-129 368, examples of compounds wherein the metal atom bears a —NR″₂ ligand see i.a. in WO9856831 and WO0034341. For the preparation see also e.g. in EP260130A, WO9728170, WO9846616, WO9849208, WO9912981, WO9919335, WO9856831, WO00/34341, EP423101A and EP537130A.

Most preferably this metallocene complex is bis(1-methyl-3-n-butylcyclopentadienyl) zirconium (IV) chloride.

### Ad Ziegler-Nattay Catalyst System

A suitable Ziegler-Natta catalyst contains a magnesium compound, an aluminium compound and a titanium compound supported on a particulate support.

The particulate support can be an inorganic oxide support, such as silica, alumina, titania, silica-alumina and silica-titania. Preferably, the support is silica.

The average particle size of the silica support can be typically from 10 to 100 μm. However, it has turned out that special advantages can be obtained if the support has an average particle size from 15 to 30 μm, preferably from 18 to 25 μm.

The magnesium compound is a reaction product of a magnesium dialkyl and an alcohol. The alcohol is a linear or branched aliphatic monoalcohol. Preferably, the alcohol has from 6 to 16 carbon atoms. Branched alcohols are especially preferred, and 2-ethyl-1-hexanol is one example of the preferred alcohols. The magnesium dialkyl may be any compound of magnesium bonding to two alkyl groups, which may be the same or different. Butyl-octyl magnesium is one example of the preferred magnesium dialkyls.

The aluminium compound is chlorine containing aluminium alkyl. Especially preferred compounds are aluminium alkyl dichlorides and aluminium alkyl sesquichlorides.

The titanium compound is a halogen containing titanium compound, preferably chlorine containing titanium compound. Especially preferred titanium compound is titanium tetrachloride.

The catalyst can be prepared by sequentially contacting the carrier with the above mentioned compounds, as described in EP-A-688794. Alternatively, it can be prepared by first preparing a solution from the components and then contacting the solution with a carrier, as described in WO-A-01/55230.

The above mentioned solid catalyst component is contacted with an aluminium alkyl cocatalyst, which preferably is an aluminium trialkyl compound, after which it can be used in polymerisation. The contacting of the solid catalyst component and the aluminium alkyl cocatalyst can either be conducted prior to introducing the catalyst into the polymerisation reactor, or it can be conducted by introducing the two components separately into the polymerisation reactor.

Suitable Ziegler-Natta catalysts and their production are for example described in EP1378528.

The HDPE can be unimodal or multimodal.

### Embodiment (I)

In embodiment (I) the HDPE is unimodal and is produced either in one polymerization stage or in a two-stage polymerization stage, wherein in both stages the same reaction conditions are applied in order to produce the same kind of polymer in both stages.

Properties of the unimodal HDPE are as described above.

Preferably, the HDPE is a multimodal HDPE.

The preferred multimodal high density polyethylene (HDPE) is called “multimodal” since it is produced in an at least two-stage polymerization process, wherein in the at least two stages at least two different polyethylene components with different properties, i.e. different densities and MFRs, are produced.

In one embodiment, the multimodal high density polyethylene (HDPE) consists of 2 polyethylene components (D) and (E), thus being a bimodal HDPE, whereby the bimodal HDPE is produced in a 2 stage-polymerization process.

In another embodiment, the polyethylene component (D) consists of ethylene polymer fractions (D-1) and (D-2), thus, the multimodal HDPE is a trimodal HDPE, whereby the trimodal HDPE is produced in a 3-stage polymerization step.

### Embodiment (II)

In a preferred embodiment, i.e. embodiment (II), the multimodal HDPE is a trimodal HDPE, which is produced in the presence of a metallocene catalyst system or a Ziegler-Natta catalyst system, preferably in the presence of a metallocene catalyst system as described above.

In embodiment (I), the polyethylene component (D) of the trimodal HDPE is an ethylene copolymer and component (E) is an ethylene homopolymer or copolymer.

Preferably, component (E) consists of a single ethylene homopolymer or copolymer. Component (D) is an ethylene copolymer mixture comprising (e.g. consisting of) a first ethylene copolymer fraction (D-1) and a second ethylene copolymer fraction (D-2), whereby the comonomer(s) in the first and second ethylene copolymer fractions are the same.

In this embodiment (II) of the present invention, the polyethylene component (D) preferably has a MFR₂ in the range of 10 to 400 g/10 min, more preferably 12 to 200 g/10 min, even more preferably 15 to 100 g/10 min and most preferably 20 to 50 g/10 min.

The density of the polyethylene component (D) preferably is in the range of 955 to 970 kg/m³, more preferably 958 to 968 kg/m³ and even more preferably 960 to 965 kg/m³.

As stated above, in embodiment (II) the polyethylene component (D) is an ethylene copolymer. Preferred ethylene copolymers employ alpha-olefins (e.g. C3-12 alpha-olefins) as comonomers. Examples of suitable alpha-olefins include 1-butene, 1-hexene and 1-octene; 1-butene is an especially preferred comonomer.

Polyethylene component (D) consists of two fractions, i.e. a first ethylene copolymer fraction (D-1) and a second ethylene copolymer fraction (D-2).

It is possible that fraction (D-1) is produced first and then fraction (D-2) is produced in the presence of fraction (D-1) in a subsequent reactor or vice versa, i.e. fraction (D-2) is produced first and then fraction (D-1) is produced in the presence of fraction (D-2) in a subsequent reactor. Preferably, fraction (D-1) is produced first.

The MFR₂ and/or the density of fractions (D-1) and (D-2) may be the same or may be different from each other.

Thus, the ethylene polymer fraction (D-1) and/or ethylene polymer fraction (D-2) preferably has a MFR₂ (190° C., 2.16 kg, ISO 1133) in the range of 10.0 to 80.0 g/10 min, preferably of 15.0 to 70.0 g/10 min, more preferably of 20.0 to 60.0 g/10 min and even more preferably of 30.0 to 50.0 g/10 min.

Preferably, the MFR₂ of fraction (D-1) is higher than the MFR₂ of fraction (D-2).

The density of the ethylene polymer fraction (D-1) and/or (D-2) preferably is in the range of 945 to 975 kg/m³, more preferably 950 to 970 kg/m³ and even more preferably 952 to 968 kg/m³.

Preferably, the density of fraction (D-2) is higher than the density of fraction (D-1).

The polyethylene component (E) preferably has a MFR₂ in the range of 0.01 to 1.0 g/10 min, more preferably 0.02 to 0.8 g/10 min, and even more preferably 0.05 to 0.5 g/10 min.

The density of the polyethylene component (E) preferably is in the range of 925 to 965 kg/m³, more preferably 930 to 962 kg/m³ and even more preferably 935 to 960 kg/m³.

As stated above polyethylene component (E) is an ethylene homopolymer or a copolymer.

The expression “homopolymer” used herein refers to a polyethylene that consists substantially, i. e. to at least 98 wt %, preferably at least 99 wt %, more preferably at least 99.5 wt %, most preferably at least 99.8 wt %.

In case that polyethylene component (E) is an ethylene copolymer, preferred ethylene copolymers employ alpha-olefins (e.g. C3-12 alpha-olefins) as comonomers. Examples of suitable alpha-olefins include 1-butene, 1-hexene and 1-octene; 1-hexene is an especially preferred comonomer.

The multimodal HDPE of embodiment (II) is produced by polymerization using conditions which create a multimodal (i.e. trimodal) polymer product.

Regarding the polymerization process in a three-stage polymerization process, it is referred to the description related to mLLDPE-1.

### Embodiment (III)

In embodiment (III), the multimodal HDPE is a bimodal HDPE, which is produced in the presence of a metallocene catalyst system or a Ziegler-Natta catalyst system (znHDPE), preferably in the presence of a Ziegler-Natta catalyst system.

The HDPE of embodiment (III) is an ethylene homopolymer or an ethylene copolymer. An ethylene copolymer is a polymer which comprises ethylene monomer and one or more comonomer(s).

The comonomer can be an alpha-olefin having 4 to 12 carbon atoms, e.g. 1-butene, 4-methyl-1-pentene, 1-hexene, 1-octene, 1-decene.

More preferably, the HDPE of embodiment (III) is a copolymer of ethylene and 1-butene, 1-hexene or 1-octene, most preferably 1-butene.

Preferably, the total amount of comonomer(s) present in the HDPE is of 0.0 to 0.40 mol %, more preferably of 0.01 to 0.30 mol % and most preferably 0.02 to 0.20 mol %.

The HDPE comprises, or consists of, a lower molecular weight (LMW) component (D) and a higher molecular weight (HMW) component (E); wherein the LMW component (D) is an ethylene homopolymer having a density of from 965 to 975 kg/m³ and the HMW component (E) is an ethylene copolymer of ethylene with at least one C4 to C12 alpha-olefin, having a density of from 935 to 955 kg/m³.

The lower molecular weight (LMW) component (D) has a lower molecular weight than the higher molecular weight component (E) and thus higher MFR₂ than the higher molecular weight (HMW) component (E).

The HDPE used according to the present invention is preferably produced in the presence of a Ziegler-Natta catalyst system and is thus a znHDPE.

As the bimodal znHDPE, resin Borstar® FB5600 as produced by Borouge may be used.

### Layer (C), Respectively Core Layer (CL)

In an embodiment, the invention provides a multilayered polyethylene film comprising at least a layer (A), being the sealing layer (SL), a layer (B) being the skin layer (SKL), and a layer (C), being a core layer (CL), whereby the core layer (CL) is located between the sealing layer (SL) and the skin layer (SKL) and wherein layer (A) and layer (B) are defined as above.

The core layer (CL) comprises:
x) 50.0 wt % to 99.0 wt %, based on the total weight of the core layer (CL), of a multimodal Ziegler-Natta catalysed linear low density polyethylene (znLLDPE-1) having a density (ISO 1183) in the range of 920 to 950 kg/m³ and an MFR₅ (190° C., 5 kg, ISO 1133) in the range of from 0.1 to 4.0 g/10 min; and
y) 1.0 wt % to 50.0 wt %, based on the total weight of the core layer (CL), of a second multimodal metallocene catalysed linear low density polyethylene (mLLDPE-2) having a density in the range of 905 to 930 kg/m³ (ISO 1183) and
a MFR₂ (190° C., 2.16 kg, ISO 1133) in the range of 0.1 to 2.0 g/10 min,
the total amounts of x)+y) summing up to 100 wt %.

Preferably, the znLLDPE-1 is present in an amount of 60.0 to 95.0 wt %, more preferably of 65.0 to 90.0 wt % and even more preferably of 70.0 to 85.0 wt %, based on the total weight of the core layer (CL).

Thus, the mLLDPE-2 is preferably present in the core layer (CL) in an amount of 5.0 to 40.0 wt %, more preferably of 10.0 to 35.0 wt % and even more preferably of 15.0 to 30.0 wt %, based on the total weight of the core layer (CL).

Ad Multimodal Ziegler-Natta Catalysed Linear Low Density Polyethylene (znLLDPE-1)

The multimodal Ziegler-Natta catalysed linear low density polyethylene (znLLDPE-1) has a density (ISO 1183) in the range of 920 to 950 kg/m³, preferably of 925 to 945 kg/m³, more preferably of 928 to 942 kg/m³, like 930 to 940 kg/m³.

The MFR₅ (190° C., 5 kg, ISO 1133) of the znLLDPE-1 is in the range of 0.1 to 4.0 g/10 min, preferably of 0.5 to 3.5 g/10 min, more preferably of 0.7 to 3.0 g/10 min, like 0.8 to 2.5 g/10 min.

The znLLDPE-1 contains at least one or two comonomer(s). Suitable comonomers are C₃-C₁₀ alpha-olefin comonomers.

Thus, the znLLDPE-1 can be a copolymer of ethylene and one C₃-C₁₀ alpha-olefin comonomer or a terpolymer of ethylene and two different C₃-C₁₀ alpha-olefin comonomers.

Preferably, the comonomers are selected from the group of 1-butene, 1-hexene and 1-octene.

It is preferred if the comonomer employed is 1-butene and/or 1-hexene.

More preferred are terpolymers comprising 1-butene and 1-hexene comonomers.

The total comonomer content of the znLLDPE is preferably in the range of 0.3 to 7.0 mol %, more preferably of 0.6 to 4.5 mol % and even more preferably of 1.5 to 3.5 mol %.

1-butene is preferably present in an amount of 0.1 to 3.0 mol %, more preferably of 0.2 to 2.0 mol %, and even more preferably of 0.3 to 1.5 mol % and 1-hexene is present in an amount of 0.2 to 4.0 mol %, more preferably of 0.4 to 2.5 mol % and even more preferably of 0.7 to 2.0 mol %.

In one embodiment of the multilayered film according to the invention, the znLLDPE-1 for layer (C), respectively the core layer (CL), comprises
(X-1) a lower molecular weight (LMW) homopolymer of ethylene and
(X-2) a higher molecular weight (HMW) terpolymer of ethylene, 1-butene and 1-hexene.

The LMW homopolymer fraction (X-1) has a lower molecular weight than the HMW terpolymer fraction (X-2).

In a further embodiment of the present invention the lower molecular weight (LMW) homopolymer of ethylene (X-1) consists of one or two fractions, i.e. of one or two homopolymers of ethylene.

In case that the lower molecular weight (LMW) homopolymer of ethylene (X-1) consists of two homopolymers of ethylene, these two fractions are named (LMW-1) and (LMW-2).

The lower molecular weight homopolymer (X-1) of the znLLDPE-1 has a melt index MFR₂ according to ISO 1133 (190° C.) in the range of from 200 to 1000 g/10 min, preferably of from 250 to 800 g/10 min; a density according to ISO 1183 in the range of from 940 to 980 kg/m³, preferably 945 to 975 kg/m³ and a comonomer content in the range of from 0 to 2.5 mol %, preferably from 0 to 2.0 mol %.

The amount of the lower molecular weight fraction (X-1) of the znLLDPE-1 is in the range of 30 to 60 wt %, preferably 35 to 50 wt % and more preferably 35 to 45 wt %.

The expression “homopolymer of ethylene” used herein refers to a polyethylene that consists substantially, i.e. to at least 98.0 wt %, preferably at least 99.0 wt % and more preferably at least 99.5 wt % by weight, like at least 99.8 wt % of ethylene.

In case that the lower molecular weight (LMW) homopolymer of ethylene (X1) consists of two homopolymers of ethylene, i.e. fractions (LMW-1) and (LMW-2), these two fractions preferably have a different MFR₂ according to ISO 1133 (190° C.).

The homopolymer fraction (LMW-1) preferably has a MFR₂ according to ISO 1133 (190° C.) in the range of 100 to 400 g/10 min, more preferably in the range of 150 to 300 g/10 min, whereas the homopolymer fraction (LMW-2) preferably has a MFR₂ according to ISO 1133 (190° C.) in the range of 450 to 1200 g/10 min, more preferably in the range of 600 to 1100 g/10 min.

The MFR₂ of fraction (LMW-1) is preferably lower than the MFR₂ of the total lower molecular weight (LMW) homopolymer of ethylene (X-1).

According to a preferred embodiment the ratio of MFR₂(LMW-1)/MFR₂(X-1) may be for example between greater than 1 and up to 10, preferably between 1.5 and 5, such as 1.5 to 4.

Ideally, the MFR difference between the first and second homopolymer fraction (LMW-1) and (LMW-2) is as high as possible.

Ideally, the MFR difference between the first homopolymer fraction (LMW-1) and the MFR₂ of the total lower molecular weight (LMW) homopolymer of ethylene (X-1) is as high as possible e.g. MFR₂ of first homopolymer fraction (LMW-1) may be at least 50 g/10 min, such as at least 100 g/10 min or such as 100 to 200 g/10 min lower than the MFR₂ of the total lower molecular weight (LMW) homopolymer of ethylene (X-1).

The density of the two homopolymer fractions (LMW-1) and (LMW-2) may be the same or may be different and is in the range of 955 to 980 kg/m³, preferably 965 to 980 kg/m³ or 965 to 975 kg/m³.

In an embodiment of the present invention the density of homopolymer fractions (LMW-1) and (LMW-2) are the same or differ +/−5 kg/m³, preferably +/−2 kg/m³.

The total lower molecular weight (LMW) homopolymer of ethylene (X-1) may comprise 30 to 60 wt % of the first ethylene homopolymer fraction (LMW-1) and 70 to 40 wt % of the second ethylene homopolymer fraction (LMW-2). In some embodiments, there is an excess of the second ethylene homopolymer fraction (LMW-2), e.g. 54 to 70 wt % of the second ethylene homopolymer fraction (LMW-2).

In another embodiment the total lower molecular weight (LMW) homopolymer of ethylene (X-1) contains the same amount of first and second ethylene homopolymer fractions (LMW-1) and (LMW-2).

The higher molecular weight fraction (X-2) has a lower MFR₂ and a lower density than the lower molecular weight fraction (X-1).

Preferably, the znLLDPE-1 is produced in a multi-stage, e.g. two-stage or three-stage polymerization using the same Ziegler-Natta catalyst in all stages. Preferably, the znLLDPE-1 is made using a slurry polymerization in at least one loop reactor followed by a gas phase polymerization in a gas phase reactor.

A loop reactor-gas phase reactor system or loop-loop-gas phase reactor system is well known as Borealis technology, i.e. a BORSTAR® reactor system.

In one embodiment, the znLLDPE-1 is thus preferably formed in a two-stage process comprising a first slurry loop polymerization followed by gas phase polymerization in the presence of a Ziegler-Natta catalyst.

Preferably, the lower molecular weight fraction (X-1) is produced in a continuously operating loop reactor where ethylene is polymerized in the presence of a Ziegler-Natta catalyst and the higher molecular weight fraction (X-2) is then formed in a gas phase reactor using the same Ziegler-Natta catalyst.

Such znLLDPEs are known in the state of the art and are described e.g. in WO 03/066698 or WO 2008/034630 or are commercially available, such as BorShape™ FX1001 and BorShape™ FX1002 (both from Borealis AG).

In another embodiment the znLLDPE-1 is preferably formed in a three-stage process preferably comprising a first slurry reactor (loop reactor 1), whereby the first slurry loop reactor is connected in series with another slurry reactor (loop reactor 2), so that the first homopolymer fraction (LMW-1) produced in the loop reactor 1 is fed to the loop reactor 2, wherein the second homopolymer fraction (LMW-2) is produced in the presence of the first fraction (LMW-1). The loop reactor 2 is thereby connected in series to a gas phase reactor (GPR), so that the total lower molecular weight fraction (X) leaving the second slurry reactor is fed to the GPR to produce the znLLDPE-1. In this case, the reaction conditions in the two slurry reactors are chosen in a way that in the two slurry reactors different products in view of MFR and/or density are produced.

Such a process is described inter alia in WO 2016/198273.

A suitable process is the Borstar PE 3G process.

Additionally the znLLDPE-1, preferably the znLLDPE-1 terpolymer may also contain one or more additives selected from antioxidants, process stabilizers, slip agents, pigments, UV-stabilizers and other additives known in the art.

Ad second multimodal metallocene catalysed linear low density polyethylene (mLLDPE-2) The mLLDPE-2 of the optional core layer (CL) is a multimodal metallocene catalysed linear low density polyethylene different from the mLLDPE-1 as defined for the sealing layer (SL).

The second multimodal metallocene catalysed linear low density polyethylene (mLLDPE-2) has a density (ISO 1183) in the range of 905 to 930 kg/m³, preferably of 910 to 925 kg/m³, more preferably of 915 to 920 kg/m³.

The MFR₂ (190° C., 2.16 kg, ISO 1133) of the mLLDPE-2 is in the range of 0.01 to 1.5 g/10 min, preferably of 0.05 to 1.2 g/10 min, more preferably of 0.1 to 1.0 g/10 min and even more preferably 0.2 to 0.8 g/10 min.

In an embodiment the mLLDPE-2 has a melt flow ratio MFR₂₁/MFR₂ of 20 to 100, preferably of 25 to 80, more preferably of 30 to 60 and even more preferably 35 to 50.

The second multimodal metallocene catalysed linear low density polyethylene (mLLDPE-2) is a copolymer of ethylene with at least two different comonomers selected from alpha-olefins having from 4 to 10 carbon atoms, e.g. 1-butene, 1-hexene, 1-octene, preferably 1-butene and 1-hexene.

In an embodiment, the second multimodal metallocene catalysed linear low density polyethylene (mLLDPE-2) of the core layer (CL) consists of
(i) 30.0 to 70.0 wt % of a polyethylene component (Y), and
(ii) 70.0 to 30.0 wt % of a polyethylene component (Z).

The amount of (Y) and (Z) add up to 100.0 wt %.

In a further embodiment of the present invention, the polyethylene component (Y) consists of ethylene polymer fractions (Y-1) and (Y-2).

It is possible that fraction (Y-1) is produced first and then fraction (Y-2) is produced in the presence of fraction (Y-1) in a subsequent reactor or vice versa, i.e. fraction (Y-2) is produced first and then fraction (Y-1) is produced in the presence of fraction (Y-2) in a subsequent reactor. Preferably fraction (Y-1) is produced first.

The multimodal metallocene catalysed linear low density polyethylene (mLLDPE-2) is referred herein as “multimodal”, since the polyethylene component (Y), optionally including ethylene polymer fractions (Y-1) and (Y-2), and polyethylene component (Z) have been produced under different polymerization conditions resulting in different Melt Flow Rates (MFR, e.g. MFR₂). I.e. the multimodal PE is multimodal at least with respect to difference in MFR of the polyethylene components (Y) and (Z).

Preferably, the alpha-olefin comonomer having from 4 to 10 carbon atoms of the polyethylene component (Y) is different from the alpha-olefin comonomer having from 4 to 10 carbon atoms of polyethylene component (Z), more preferably the alpha-olefin comonomer having from 4 to 10 carbon atoms of polyethylene component (Y) is selected from 1-butene, 1-hexene and 1-octene, more preferably is 1-butene; and the alpha-olefin comonomer having from 4 to 10 carbon atoms of polyethylene component (Z) is preferably selected from 1-hexene and 1-octene, more preferably is 1-hexene.

The comonomer type for the polymer fractions (Y-1) and (Y-2) is the same, thus the same alpha-olefin comonomer having from 4 to 10 carbon atoms is used for fraction (Y-1) and (Y-2), more preferably both fractions therefore have 1-butene as comonomer.

Thus, in a preferred embodiment polyethylene component (Y) is an ethylene-1-butene polymer component (Y) and polyethylene component (Z) is an ethylene-1-hexene polymer component (B).

The MFR₂ of the ethylene polymer components (Y) and (Z) are different from each other.

The ethylene polymer component (Y) has a MFR₂ (190° C., 2.16 kg, ISO 1133) in the range of 10.0 to 400 g/10 min, preferably of 30.0 to 350 g/10 min, more preferably of 50.0 to 300 g/10 min, even more preferably of 80.0 to 250 g/10 min and still more preferably of 100 to 200 g/10 min, like 120 to 160 g/10 min.

The ethylene polymer component (Z) has a MFR₂ (190° C., 2.16 kg, ISO 1133) in the range of 0.0001 to 1.0 g/10 min, preferably of 0.0005 to 0.5 g/10 min, more preferably of 0.001 to 0.1 g/10 min and even more preferably of 0.002 to 0.01 g/10 min.

In case that the ethylene-1-butene polymer component (Y) consists of ethylene polymer fractions (Y-1) and (Y-2), the MFR₂ of the ethylene polymer fractions (Y-1) and (Y-2) may be different from each other or may be the same.

The ethylene polymer fraction (Y-1) has a MFR₂ (190° C., 2.16 kg, ISO 1133) in the range of 5.0 to 800.0 g/10 min, preferably of 10.0 to 400.0 g/10 min, more preferably of 20.0 to 200.0 g/10 min and even more preferably of 25.0 to 150.0 g/10 min, like 30.0 to 100.0 g/10 min.

The ethylene polymer fraction (Y-2) has a MFR₂ (190° C., 2.16 kg, ISO 1133) in the range of 50 to 1000 g/10 min, preferably of 100 to 800 g/10 min, more preferably of 200 to 600 g/10 min and most preferably of 300 to 550 g/10 min.

Preferably the MFR₂ of ethylene polymer fraction (Y-2) is higher than the MFR₂ of the ethylene polymer fraction (Y-1).

In an embodiment of the invention it is preferred the ratio of the MFR₂ (190° C., 2.16 kg, ISO 1133) of ethylene-1-butene polymer component (Y) to the MFR₂ (190° C., 2.16 kg, ISO 1133) of the final multimodal metallocene catalysed linear low density polyethylene (mLLDPE-2) is at least 100 to 600, preferably 200 to 500 and more preferably of 300 to 400.

The density of the ethylene polymer component (Y) is in the range of 930 to 960 kg/m³, preferably of 935 to 955 kg/m³, more preferably of 940 to 950 kg/m³ and/or the density of the ethylene polymer component (Z) is of in the range of 885 to 910 kg/m³, preferably of 890 to 905 kg/m³ and more preferably of 893 to 900 kg/m³.

In case that the ethylene-1-butene polymer component (Y) consists of ethylene polymer fractions (Y-1) and (Y-2) the density of the ethylene polymer fractions (Y-1) and (Y-2) may be different from each other or may be the same.

The polymer fraction (Y-1) has a density in the range of 930 to 960 kg/m³, preferably of 935 to 955 kg/m³, more preferably of 940 to 950 kg/m³.

The density of the polymer fraction (Y-2) is in the range of 935 to 955 kg/m³, preferably of 940 to 950 kg/m³.

It is within the scope of the invention, that the first and the second ethylene polymer fraction (Y-1 and Y-2) of the polyethylene component (Y) are present in a weight ratio of 4:1 up to 1:4, such as 3:1 to 1:3, or 2:1 to 1:2, or 1:1.

The polyethylene component (Y) is present in an amount of 30.0 to 70.0 wt % based on the multimodal metallocene catalysed linear low density polyethylene (mLLDPE-2), preferably in an amount of 32.0 to 55.0 wt % and even more preferably in an amount of 34.0 to 45.0 wt %.

Thus, the polyethylene component (Z) is present in an amount of 70.0 to 30.0 wt % based on the multimodal metallocene catalysed linear low density polyethylene (mLLDPE-2), preferably in an amount of 68.0 to 45.0 wt % and more preferably in an amount of 66.0 to 55.0 wt %.

The multimodal metallocene catalysed linear low density polyethylene (mLLDPE-2), can be produced in a 2-stage or 3-stage polymerization process as described for the first multimodal metallocene catalysed linear low density polyethylene (mLLDPE-1).

The mLLDPE-2 is formed using a metallocene catalyst.

In a further embodiment the mLLDPE-2 can also be produced in the presence of a metallocene complex of formula (I), as described for mLLDPE-1.

The mLLDPE-2 may optional contain additives and/or fillers.

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

### Multilayer Film

The multilayered polyethylene film of the present invention comprises at least a layer (A), being the sealing layer (SL), and a layer (B), being the skin layer (SKL).

In an embodiment, the invention provides a multilayered polyethylene film comprising at least a layer (A), being the sealing layer (SL), a layer (B) being the skin layer (SKL), and a layer (C), being the core layer (CL), whereby the core layer (CL) is located between the sealing layer (SL) and the skin layer (SKL).

Preferably, the multilayered film according to this invention consists of layer (A), being the sealing layer (SL), layer (B) being the skin layer (SKL), and layer (C), being the core layer (CL).

The core layer (CL) is sandwiched between the skin layer (SKL) and the sealing layer (SL). The core layer (CL) is preferably in direct contact with the skin layer (SKL). The core layer (CL) is preferably in direct contact with the sealing layer (SL). The core layer (CL) is preferably in direct contact with the sealing layer (SL) and the skin layer (SKL).

Thus, the preferred film structure is SL/CL/SKL, respectively A/C/B.

The multilayered films of the invention can be prepared using blown extrusion techniques that are well known in the art. An appropriate blend of the components required for each layer can be blended and coextruded. It will be appreciated that any layer of the film of the invention may also contain standard polymer additives if required.

The multilayered films of the invention may have a thickness of 20 to 120 μm, preferably 30 to 100 μm and more preferably 40 to 80 μm. Films of the invention are preferably not stretched in the machine or transverse or biaxial direction.

For the three-layer structure, the sealing layer (SL), the skin layer (SKL) and the core layer (CL) may all be of equal thickness or alternatively the core layer (CL) may be thicker than the skin layer (SKL) and the sealing layer (SL).

A convenient film comprises an skin (SKL) and a sealing layer (SL), each forming 10.0 to 35.0%, preferably 15.0 to 30.0%, more preferably 18.0 to 25.0% of the total final thickness of the 3-layered film, the core layer (CL) forming the remaining thickness, e.g. 30.0 to 80.0%, preferably 40.0 to 70.0%, more preferably 50.0 to 64.0% of the total final thickness of the 3-layered film.

The total thickness of the film is 100%, thus the sum of the individual layers has to be 100%.

The films of the invention are characterized by a hot tack force (maximum Hot tack force) of at least 5.8 N or more, when measured according to ASTM F 1921-98 (2004), method B on a three-layered blown film sample (60 μm thickness).

Preferably, the hot tack force (HTF) is in the range of 5.8 N up to 15.0 N, more preferably in the range of 6.6 to 12.0 N and even more preferably in the range of 7.5 to 10.0 N.

In an embodiment of the invention the multilayered films have a hot tack temperature (HTT) of less than 87° C., when measured according to ASTM F 1921-98 method B on a three-layered blown film sample (60 μm thickness).

Preferably, the hot tack temperature (HTT) is in the range of 65 to 86° C., more preferably in the range of 68 to 85° C. and even more preferably in the range of 70 to 82° C.

The films of the invention may have a sealing initiation temperature (SIT) determined as described in the experimental part on a 3-layered blown film with a thickness of 60 μm of below 86° C., preferably in the range of 60 to 85° C., more preferably in the range of 62° C. to 84° C., and even more preferably in the range of 65° C. to 80° C.

In another embodiment, the films of the invention are additionally characterized by a dart-drop impact strength (DDI) determined according to ISO 7765-1:1988 on a 60 μm 3-layered test blown film of at least 200 g up to 1000 g, preferably 250 g up to 800 g and more preferably 300 g up to 600 g.

Films according to the present invention may have a haze measured according to ASTM D1003 on a 60 μm 3-layered test blown film of below 50%, preferably in the range of 5 to 48%, more preferably 10 to 45% and even more preferably 15 to below 41%.

In yet another embodiment the multilayered films according to the present invention are characterized by having at least
a) a hot tack force (maximum Hot tack force (HTF)), when measured according to ASTM F 1921-98 (2004), method B on a three-layered blown film sample (60 μm thickness) in the range of 5.8 N up to 15.0 N, more preferably in the range of 6.6 to 12.0 N and even more preferably in the range of 7.5 to 10.0 N and
b) a hot tack temperature (HTT) of less than 90° C., when measured according to ASTM F 1921-98, method B on a three-layered blown film sample (60 μm thickness), in the range of 65 to 86° C., more preferably in the range of 68 to 85° C. and even more preferably in the range of 70 to 82° C. and
c) a haze measured according to ASTM D1003 on a 60 μm 3-layered test blown film in the range of 5 to 48%, more preferably 10 to 45% and even more preferably 15 to below 41%.

In a further embodiment the multilayered films according to the present invention fulfil the inequation (I) (SIT+HTT)/HTF<23, preferably <22 and more preferably <21, whereby SIT is the sealing initiation temperature determined as described in the experimental part on a 3-layered blown film with a thickness of 60 μm, HTT is the hot tack temperature measured according to ASTM F 1921-98 method B on a three-layered test blown film sample with a thickness of 60 μm and HTF is the hot tack force, when measured according to ASTM F 1921-98 (2004), method B on a three-layered test blown film sample with a thickness of 60 μm.

The inventive multilayered films are fully recyclable and thus improves sustainability, as it is a “100% PE” solution with no other polymer than ethylene based polymers being present.

Multilayered films according to the present invention are highly useful for being used in various packaging applications, wherein applications related to food packaging are preferred.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

Calculation of MFR₂ of Component B and of Fraction (A-2) of mLLDPE-1

$$log A = x \cdot log B + ( 1 - x ) \cdot log C$$

$$C = 10 {\hat{}}^{\frac{( log A - x \cdot log B )}{( 1 - x )}}$$

### For Component B:

B=MFR₂ of Component (A)
C=MFR₂ of Component (B)
A=final MFR₂ (mixture) of multimodal polyethylene copolymer (P)
X=weight fraction of Component (A)

### For Fraction (A-2):

B=MFR₂ of 1^{st} fraction (A-1)
C=MFR₂ of 2^{nd} fraction (A-2)
A=final MFR₂ (mixture) of loop polymer (=Component (A))
X=weight fraction of the 1^{st} fraction (A-1)

The above formulas are applied accordingly also to the components and fractions of the HDPE, znLLDPE-1 and mLLDPE-2

### Density

Density of the polymer was measured according to ISO 1183 on compression moulded specimen prepared according to EN ISO 1872-2 (February 2007) and is given in kg/m³.

### DSC Analysis, Melting (Tm)

Data were measured with a TA Instrument Q2000 differential scanning calorimetry (DSC) on 5 to 7 mg samples. DSC was run according to ISO 11357/part 3/method C2 in a heat/cool/heat cycle with a scan rate of 10° C./min in the temperature range of −30 to +225° C.

Crystallization temperature (T_{c}) and crystallization enthalpy (H_{c}) were determined from the cooling step, while melting temperature (Tₘ) and melting enthalpy (Hₘ) are determined from the second heating step.

### Comonomer Contents:

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification.{klimke06, parkinson07, castignolles09} Standard single-pulse excitation was employed utilising the NOE at short recycle delays{pollard04, klimke06} and the RS-HEPT decoupling scheme{fillip05,griffin07}. A total of 1024 (1 k) transients were acquired per spectra. Quantitative ¹³C{¹H} NMR spectra were processed, integrated and relevant quantitative properties determined from the integrals. All chemical shifts are internally referenced to the bulk methylene signal (6+) at 30.00 ppm.

The amount of ethylene was quantified using the integral of the methylene (6+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

fBtotal=(Btotal/(Etotal+Btotal+Htotal)

The amount isolated 1-butene incorporated in EEBEE sequences was quantified using the integral of the *B2 sites at 38.3 ppm accounting for the number of reporting sites per comonomer:

B=I_{*B2}

The amount consecutively incorporated 1-butene in EEBBEE sequences was quantified using the integral of the ααB2B2 site at 39.4 ppm accounting for the number of reporting sites per comonomer:

$$BB = 2 * I αα B 2 B 2$$

The amount non consecutively incorporated 1-butene in EEBEBEE sequences was quantified using the integral of the ββB2B2 site at 24.7 ppm accounting for the number of reporting sites per comonomer:

$$BEB = 2 * I ββ B 2 B 2$$

Due to the overlap of the *B2 and *βB2B2 sites of isolated (EEBEE) and non-consecutively incorporated (EEBEBEE) 1-butene respectively the total amount of isolated 1-butene incorporation is corrected based on the amount of non-consecutive 1-butene present:

$$B = {I}_{* B 2} - 2 * {I}_{β β B 2 B 2}$$

The total 1-butene content was calculated based on the sum of isolated, consecutive and non consecutively incorporated 1-butene:

$$Btotal = B + BB + BEB$$

The total mole fraction of 1-butene in the polymer was then calculated as:

$$fB = ( Btotal / ( Etotal + Btotal + Htotal )$$

Characteristic signals corresponding to the incorporation of 1-hexene were observed and the comonomer fraction calculated as the fraction of 1-hexene in the polymer with respect to all monomer in the polymer:

$$fHtotal = ( Htotal / ( Etotal + Btotal + Htotal )$$

The amount isolated 1-hexene incorporated in EEHEE sequences was quantified using the integral of the *B4 sites at 39.9 ppm accounting for the number of reporting sites per comonomer:

H=I_{*B4}

The amount consecutively incorporated 1-hexene in EEHHEE sequences was quantified using the integral of the ααB4B4 site at 40.5 ppm accounting for the number of reporting sites per comonomer:

$$HH = 2 * I αα B 4 B 4$$

The amount non consecutively incorporated 1-hexene in EEHEHEE sequences was quantified using the integral of the ββB4B4 site at 24.7 ppm accounting for the number of reporting sites per comonomer:

$$HEH = 2 * I ββ B 4 B 4$$

The total mole fraction of 1-hexene in the polymer was then calculated as:

fH=(Htotal/(Etotal+Btotal+Htotal)

The mole percent comonomer incorporation is calculated from the mole fraction:

$$B [ mol \% ] = 100 * fB$$

$$H [ mol \% ] = 100 * fH$$

The weight percent comonomer incorporation is calculated from the mole fraction:

$$B [ wt \% ] = 100 * ( fB * 56.11 ) / ( ( fB * 56.11 ) + ( fH * 84.16 ) + ( ( 1 - ( fB + fH ) ) * 28. 05 ) )$$

$$B [ wt \% ] = 100 * ( fH * 84.16 ) / ( ( fB * 56.11 ) + ( fH * 84.16 ) + ( ( 1 - ( fB + fH ) ) * 28. 05 ) )$$

### REFERENCES

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128. Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239
Griffin, J. M., Tripon, C., Samoson, A., Filip, C., and Brown, S. P., Mag. Res. in Chem. 2007 45, S1, S198
Castignolles, P., Graf, R., Parkinson, M., Wilhelm, M., Gaborieau, M., Polymer 50 (2009) 2373
Busico, V., Cipullo, R., Prog. Polym. Sci. 26 (2001) 443
Busico, V., Cipullo, R., Monaco, G., Vacatello, M., Segre, A. L., Macromoleucles 30 (1997) 6251
Zhou, Z., Kuemmerle, R., Qiu, X., Redwine, D., Cong, R., Taha, A., Baugh, D. Winniford, B., J. Mag. Reson. 187 (2007) 225
Busico, V., Carbonniere, P., Cipullo, R., Pellecchia, R., Severn, J., Talarico, G., Macromol. Rapid Commun. 2007, 28, 1128
Resconi, L., Cavallo, L., Fait, A., Piemontesi, F., Chem. Rev. 2000, 100, 1253

### Sealing Initiation Temperature (SIT); Sealing End Temperature (SET), Sealing Range:

The method determines the sealing temperature range (sealing range) of polyethylene films, in particular blown films or cast films. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, cooling time and test speed have been modified. The determination of the force/temperature curve was continued until thermal failure of the film.

The sealing range was determined on a J&B Universal Sealing Machine Type 4000 with a 3 layer test blown film of 60 μm thickness with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient −240° C.
Sealing temperature interval: 5° C.
Start temperature: 50° C. Grip separation rate: 42 mm/sec

Hot Tack temperature (lowest temperature to get maximum Hot tack force) and Hot tack (maximum Hot tack force) were measured according to ASTM F 1921 method B on a three-layer blown film of 60 μm thickness with below settings:
Q-name instrument: Hot Tack—Sealing Tester
Model: J&B model 4000 MB
Sealbar length: 50 [mm]
Seal bar width: 5 [mm]
Seal bar shape: flat
Seal Pressure: 0.15 N/mm²
Seal Time: 1 s
Coating of sealing bars: NIPTEF®
Roughness of coating sealing bars: 1 [μm]
Film Specimen width: 25 mm
Cool time: 0.2 s
Peel Speed: 200 mm/s
Start temperature: 50° C.
End temperature: burn through and/or shrinking
Increments: 5° C.

All film test specimens were prepared in standard atmospheres for conditioning and testing at 23° C. (±2° C.) and 50% (±10%) relative humidity. The minimum conditioning time of test specimen in standard atmosphere just before start testing is at least 40 h. The minimum storage time between extrusion of film sample and start testing is at least 88 h. The hot-tack measurement determines the strength of heat seals formed in the films, immediately after the seal has been made and before it cools to ambient temperature.

The hot-tack force was measured as a function of temperature within the temperature range and with temperature increments as indicated above. The number of test specimens were at least 3 specimens per temperature. The Hot-tack force is evaluated as the highest force (maximum peak value) with failure mode “peel”.

### Dart Drop Strength (DDI): Impact Resistance by Free-Falling Dart Method

The DDI was measured according to ISO 7765-1:1988/Method A from the films (non-oriented films and laminates) as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Results

Impact failure weight—50% [g]

### Haze

Haze was determined according to ASTM D 1003-00 on 3 layered films with 60 μm thickness as produced indicated below.

### Film Sample Preparation

The 3-layer test films consisting of Layers A, B and C and respective comparative 3-layer films of 60 μm thickness were produced on a Dr. Colin 3-Layer blown film line.

The melt temperature was fixed to 210° C. The throughput of the extruders was in sum 10 kg/h. Further parameters for the blown film line were: Die Gap: 1.5 mm, Die Size: 60 mm, BUR:
1:2.5 and Frost Line Height: 120 mm

### EXAMPLES

### Materials Used:

Multimodal Ziegler-Natta catalysed linear low density polyethylene (znLLDPE-1) for Layer (C) for IE1 to IE4 and for Layer (B) of CE1:
   FX1001: multimodal alpha-olefin terpolymer commercially available by Borealis AG, with density of 931 kg/m³, a MFR₅ (190° C./5 kg) of 0.9 g/10 min, Tm 127° C.; produced with a Ziegler-Natta catalyst. It contains antioxidant.
Multimodal metallocene catalysed linear low density polyethylene for Layer A of Comparative Example CE2:
   Anteo™ FK1820: bimodal ethylene/1-butene/1-hexene terpolymer with a density of 918 kg/m³, MFR₂ (190° C./2.16 kg) of 1.5 g/10 min, Tm 122° C., produced with a metallocene catalyst; commercially available from Borouge. It contains antioxidant and processing aid.
Multimodal high density polyethylene (HDPE) for Layer (B):
   HDPE Borstar® FB5600 from Borouge has been used, FB5600 is a bimodal ethylene copolymer, density 960 kg/m³, Tm 132° C., MFR₂ 0.7 g/10 min, MFR₅ 2.5 g/10 min, MFR₂₁ 42 g/10 min. MFR₂₁/MFR₅ 16.8.
      Preparation of Multimodal Metallocene Catalysed Linear Low Density Polyethylene for Layer A of the Inventive Multilayered Films (mLLDPE-1)

### Cat. Example: Catalyst Preparation for CAT1

### Loading of SiO2:

10 kg of silica (PQ Corporation ES757, calcined 600° C.) was added from a feeding drum and inertized in the reactor until O₂ level below 2 ppm was reached.

### Preparation of MAO/Tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 1000 (oil circulation temp) and stirring was turned to 40 rpm during MAO/tol/MC addition. MAO/tol/MC solution (22.2 kg) was added within 205 min followed by 60 min stirring time (oil circulation temp was set to 2500). After stirring “dry mixture” was stabilised for 12 h at 2500 (oil circulation temp), stirring 0 rpm. Reactor was turned 200 (back and forth) and stirring was turned on 5 rpm for few rounds once an hour.

After stabilisation the catalyst was dried at 6000 (oil circulation temp) for 2 h under nitrogen flow 2 kg/h, followed by 13 h under vacuum (same nitrogen flow with stirring 5 rpm). Dried catalyst was sampled and HO content was measured in the glove box with Sartorius Moisture Analyser, (Model MA45) using thermogravimetric method. Target HO level was <2% (actual 1.3%).

### Polymerization:

Borstar pilot plant with a 3-reactor set-up (loop1-loop2-GPR 1) and a prepolymerization loop reactor.

mLLDPE-1-A for IE1-IE3 and CE1, as well as mLLDPE-1-B for IE4 were produced by using the polymerization conditions as given in Table 1.

TABLE 1
Polymerization conditions for mLLDPE-1-A and mLLDPE-1-B

| | mLLDPE-1-A | mLLDPE-1-B |
|---|---|---|
| Prepoly reactor | | |
| Catalyst feed (g/h) | 35 | 32 |
| Temp. (° C.) | 50 | 50 |
| Press. (kPa) | 5617 | 5606 |
| C2 (kg/h) | 4.0 | 4.0 |
| H2(g/h) | 0.03 | 0.03 |
| C4 (g/h) | 80.6 | 78.8 |
| Split (wt %) | 3.5 | 3.6 |
| loop 1 Fraction (A-1) | | |
| Temp. (° C.) | 85 | 85 |
| Press. (kPa) | 5537 | 5606 |
| C2 conc. (mol %) | 3.7 | 4.0 |
| H2/C2 ratio (mol/kmol) | 0.50 | 0.39 |
| C4/C2 ratio (mol/kmol) | 40 | 41.0 |
| Split (wt %) | 17.8 | 17.9 |
| Density (kg/m3) of loop 1 | 943 | 940.1 |
| material (fraction (A-1)) | | |
| MFR2 (g/10 min) of loop 1 | 10.0 | 2.2 |
| material (fraction (A-1)) | | |
| loop 2 | | |
| Temp. (° C.) | 85 | 85 |
| Press. (kPa) | 5337 | 5335 |
| C2 conc. (mol %) | 4.1 | 4.2 |
| H2/C2 ratio (mol/kmol) | 0.5 | 0.5 |
| C4/C2 ratio (mol/kmol) | 28 | 27 |
| Split (wt %) | 20 | 20.7 |
| Density (kg/m3) after | 942.3 | 940.3 |
| loop 2 (component (A)) | | |
| MFR2 (g/10 min) after | 7.5 | 4.7 |
| loop 2 (component (A)) | | |
| MFR2 (g/10 min) of loop 2 | 5.5 | 10.4 |
| material (fraction (A-2)) | | |
| Density (kg/m3) of loop 2 | 941 | 940.5 |
| material (fraction (A-2)) | | |
| C4 (wt %) after loop 2 | 1.21 | 1.19 |
| material (Component (A)) | | |
| GPR | | |
| Temp. (° C.) | 75 | 75 |
| Press. (kPa) | 2000 | 2000 |
| H2/C2 ratio (mol/kmol) | 1.05 | 1.02 |
| C6/C2 ratio (mol/kmol) | 14.04 | 11.78 |
| Split (wt %) | 58.7 | 57.9 |
| MFR2 (g/10 min) of GPR | 0.3 | 0.3 |
| material (Component (B)) | | |
| Density (kg/m3) of GPR | 891 | 900 |
| material (Component (B)) | | |
| C6 (wt %) of GPR material | 18.23 | 12.08 |
| Component (B)) | | |

The polymers were mixed with 2400 ppm of Irganox B561 (commercially available from BASF SE) and 270 ppm of Dynamar FX 5922 (commercially available from 3M) compounded and extruded under nitrogen atmosphere to pellets by using a JSW extruder so that the SEI was 230 kWh/kg and the melt temperature 250° C.

TABLE 2
Properties of mLLDPE-1-A, mLLDPE-
1-B and Comparative mLLDPE FK1820

| Material | mLLDPE-1-A | mLLDPE-1-B | FK1820 |
|---|---|---|---|
| MFR₂ (g/10 min) | 1.0 | 1.0 | 1.5 |
| (final) | | | |
| MFR₂₁ (g/10 min) | 30.1 | 29.6 | 27.1 |
| MFR₂₁/MFR₂ | 30.1 | 29.6 | 18.1 |
| Density (kg/m³) | 913 | 917 | 918 |
| C4 (wt %) | 0.5 | 0.5 | 0.6 |
| C6 (wt %) | 10.9 | 7.0 | 7.7 |
| MFR₂(A)/MFR₂(final) | 7.5 | 4.7 | 2.9 |

### Preparation of Multimodal High Density Polyethylene for Layer B of the Inventive Multilayered Films (HDPE):

### Cat. Example: Catalyst Preparation for CAT2 for CE1

130 grams of a metallocene complex bis(1-methyl-3-n-butylcyclopentadienyl) zirconium (IV) dichloride (CAS no. 151840-68-5), and 9.67 kg of a 30% solution of commercial methylalumoxane (MAO) in toluene were combined and 3.18 kg dry, purified toluene was added. The thus obtained complex solution was added onto 17 kg silica carrier Sylopol 55 SJ (supplied by Grace) by very slow uniform spraying over 2 hours. The temperature was kept below 3000. The mixture was allowed to react for 3 hours after complex addition at 3000.

### Cat. Example: Catalyst Preparation for CAT1 for IE2 See Above (as Described for mLLDPE-1)

### Polymerization:

Borstar pilot plant with a 3-reactor set-up (loop1-loop2-GPR 1) and a prepolymerization loop reactor.

HDPE-A for IE1, as well as HDPE-B for IE2 were produced by using the polymerization conditions as given in Table 3.

TABLE 3
Polymerization conditions for HDPE-A and HDPE-B

| | HDPE-1 | HDPE-2 |
|---|---|---|
| Catalyst | CAT2 | CAT1 |
| Prepoly reactor | | |
| Catalyst feed (g/h) | 50 | 50.1 |
| Temp. (° C.) | 50 | 50 |
| Press. (kPa) | 5854 | 5848 |
| C2 (kg/h) | 4.0 | 4.0 |
| H2(g/h) | 0.2 | 0.02 |
| C4 (g/h) | 101.4 | 75.1 |
| Split (wt %) | 3.2 | 3.7 |
| loop 1 Fraction (D-1) | | |
| Temp. (° C.) | 85 | 85 |
| Press. (kPa) | 5668 | 5445 |
| C2 conc. (mol %) | 5.6 | 4.6 |
| H2/C2 ratio (mol/kmol) | 0.25 | 0.60 |
| C4/C2 ratio (mol/kmol) | 6.6 | 3.6 |
| Split (wt %) | 26.7 | 19.5 |
| Density (kg/m3) of loop 1 | 960.6 | 960.8 |
| material (fraction (D-1)) | | |
| MFR₂ (g/10 min) of | 35.5 | 43.6 |
| loop 1 material (fraction (D-1)) | | |
| loop 2 | | |
| Temp. (° C.) | 85 | 85 |
| Press. (kPa) | 5569 | 5391 |
| C2 conc. (mol %) | 3.8 | 4.1 |
| H2/C2 ratio (mol/kmol) | 0.04 | 0.3 |
| C4/C2 ratio (mol/kmol) | 5.0 | 1.0 |
| Split (wt %) | 20.1 | 22.5 |
| Density (kg/m3) after loop 2 (component (D)) | 963.0 | 963.7 |
| MFR₂ (g/10 min) after | 32.0 | 30.0 |
| loop 2 (component (D)) | | |
| MFR₂ (g/10 min) of loop 2 | 27.4 | 20.3 |
| material (fraction (D-2)) | | |
| Density (kg/m3) of loop 2 | 966.6 | 966.7 |
| material (fraction (D-2)) | | |
| GPR | | |
| Temp. (° C.) | 80 | 85 |
| Press. (kPa) | 2000 | 2000 |
| H2/C2 ratio (mol/kmol) | 0.06 | 0.47 |
| C6/C2 ratio (mol/kmol) | 3.68 | 0.02 |
| Split (wt %) | 50.0 | 54.2 |
| MFR₂ (g/10 min) of GPR | 0.1 | 0.16 |
| material (Component (E)) | | |
| Density (kg/m³) of GPR | 936.6 | 955.0 |
| material (Component (E)) | | |

The polymers were mixed with 2400 ppm of Irganox B561 (commercially available from BASF SE) and 270 ppm of Dynamar FX 5922 (commercially available from 3M) compounded and extruded under nitrogen atmosphere to pellets by using a JSW extruder so that the SEI was 230 kWh/kg and the melt temperature 250° C.

TABLE 4
Material properties of HDPE-1 and HDPE-2

| Material | HDPE-1 | HDPE-2 |
|---|---|---|
| MFR₂ (g/10 min) (final) | 1.9 | 1.8 |
| MFR₅ (g/10 min) | 3.1 | 5.0 |
| MFR₂₁ (g/10 min) | 35.9 | 47.3 |
| MFR₂₁/MFR₅ | 11.6 | 9.46 |
| Density (kg/m³) | 951.6 | 959.0 |
| Tm (° C.) | 131 | 132 |

Preparation of Multimodal Metallocene Catalysed Linear Low Density Polyethylene for Layer C of the Inventive Multilayered Films (mLLDPE-2)

### Cat. Example: Catalyst Preparation for CAT1 See Above (as Described for mLLDPE-1)

### Polymerization:

Borstar pilot plant with a 3-reactor set-up (loop1-loop2-GPR 1) and a prepolymerization loop reactor.

mLLDPE-2 was produced by using the polymerization conditions as given in Table 5.

TABLE 5
Polymerization conditions for mLLDPE-2

| | mLLDPE-2 |
|---|---|
| Prepoly reactor | |
| Catalyst feed (g/h) | 32.6 |
| Temp. (° C.) | 50 |
| Press. (kPa) | 5766 |
| C2 (kg/h) | 4.0 |
| H2(g/h) | 0.1 |
| C4 (g/h) | 87.4 |
| Split (wt %) | 3.7 |
| loop 1 Fraction (Y-1) | |
| Temp. (° C.) | 85 |
| Press. (kPa) | 5235 |
| C2 conc. (mol %) | 3.9 |
| H2/C2 ratio (mol/kmol) | 0.89 |
| C4/C2 ratio (mol/kmol) | 61.2 |
| Split (wt %) | 19.8 |
| Density (kg/m3) of loop 1 material (fraction (Y-1)) | 943.4 |
| MFR2 (g/10 min) of loop 1 material (fraction (Y-1)) | 52.0 |
| loop 2 | |
| Temp. (° C.) | 85 |
| Press. (kPa) | 5363 |
| C2 conc. (mol %) | 4.4 |
| H2/C2 ratio (mol/kmol) | 1.0 |
| C4/C2 ratio (mol/kmol) | 47 |
| Split (wt %) | 21.5 |
| Density (kg/m3) after loop 2 (component (Y)) | 945.3 |
| MFR₂ (g/10 min) after loop 2 (component (Y)) | 144.0 |
| MFR₂ (g/10 min) of loop 2 material (fraction (Y-2)) | 434 |
| Density (kg/m³) of loop 2 material (fraction (Y-2)) | 947.4 |
| GPR | |
| Temp. (° C.) | 75 |
| Press. (kPa) | 2000 |
| H2/C2 ratio (mol/kmol) | 0.63 |
| C6/C2 ratio (mol/kmol) | 9.93 |
| Split (wt %) | 55.0 |
| MFR₂ (g/10 min) of GPR material (Component (Z)) | 0.004 |
| Density (kg/m³) of GPR material (Component (Z)) | 896 |

The polymer was mixed with 2400 ppm of Irganox B561 (commercially available from BASF SE) and 270 ppm of Dynamar FX 5922 (commercially available from 3M) compounded and extruded under nitrogen atmosphere to pellets by using a JSW extruder so that the SEI was 230 kWh/kg and the melt temperature 250° C.

TABLE 6
Material properties of mLLDPE-2

| Material | mLLDPE-2 |
|---|---|
| MFR₂ (g/10 min) (final) | 0.44 |
| MFR₅ (g/10 min) | 1.42 |
| MFR₂₁ (g/10 min) | 19.5 |
| MFR₂₁/MFR₂ | 44.3 |
| MFR₂(Y)/MFR₂(final) | 327 |
| Density (kg/m³) | 918.2 |

### Three-Layered Films

The following three-layered film structures have been produced with the above described method (film sample preparation).

TABLE 7
Inventive and Comparative Film structures

| Layer/thickness | [wt %]* | CE1 | IE1 | IE2 | IE3 | IE4 | CE2 |
|---|---|---|---|---|---|---|---|
| Skin layer | 100 | FX1001 | HDPE-1 | HDPE-2 | FB5600 | FB5600 | FB5600 |
| (SKL)/12 μm | | | | | | | |
| Core layer | 80 | FX1001 | FX1001 | FX1001 | FX1001 | FX1001 | FX1001 |
| (CL)/36 μm | 20 | mLLDPE-2 | mLLDPE-2 | mLLDPE-2 | mLLDPE-2 | mLLDPE-2 | mLLDPE-2 |
| Sealing layer | 100 | mLLDPE-1A | mLLDPE-1A | mLLDPE-1A | mLLDPE-1A | mLLDPE-1B | FK1820 |
| (SL)/12 μm | | | | | | | |

*wt % based on the respective layer (SKL or CL or SL)

TABLE 8
Inventive and Comparative Film structures

| Layer/thickness | [wt %]** | CE1 | IE1 | IE2 | IE3 | IE4 | CE2 |
|---|---|---|---|---|---|---|---|
| Skin layer | 20 | FX1001 | HDPE-1 | HDPE-2 | FB5600 | FB5600 | FB5600 |
| (SKL)/12 μm | | | | | | | |
| Core layer | 48 | FX1001 | FX1001 | FX1001 | FX1001 | FX1001 | FX1001 |
| (CL)/36 μm | 12 | mLLDPE-2 | mLLDPE-2 | mLLDPE-2 | mLLDPE-2 | mLLDPE-2 | mLLDPE-2 |
| Sealing layer | 20 | mLLDPE-1A | mLLDPE-1A | mLLDPE-1A | mLLDPE-1A | mLLDPE-1B | FK1820 |
| (SL)/12 μm | | | | | | | |

**wt % based on the overall 3-layered film

In Table 9 the film properties of the inventive and comparative film structures are shown.

TABLE 9
Film properties

| Property | unit | CE1 | IE1 | IE2 | IE3 | IE4 | CE2 |
|---|---|---|---|---|---|---|---|
| DDI | g | 660 | 436 | 407 | 371 | 455 | 408 |
| Haze | % | 63.4 | 22.1 | 24.1 | 37.3 | 40.5 | 41.1 |
| SIT | ° C. | 66 | 66 | 67 | 67 | 79 | 81 |
| HTT | ° C. | 66 | 71 | 71 | 71 | 80 | 87 |
| HTF | N | 5.7 | 9.3 | 8.4 | 9.0 | 7.7 | 7.2 |
| (SIT + HTT)/HTF | | 23.2 | 14.7 | 16.4 | 15.3 | 20.7 | 23.3 |

The data demonstrates that if the sealing layer (SL) is the same, i.e. IE1-IE3 and CE1, in combination with an HDPE according to the present invention in the skin layer (SKL), the HTF is clearly higher for the inventive Examples IE1-IE3 than for CE1. In addition also haze of IE1-IE3 is clearly lower than for CE1, although the skin layer of CE1 has much lower density.

In case that the skin layer (SKI) is the same, i.e. IE4 and CE2, but the mLLDPE-1 in the sealing layer (SL) is different (i.e. mLLDPE-1 vs FK1820), then the optic parameters, i.e. haze are comparable, but DDI and also the HTF are higher for IE4 than for CE2.

In general, the multilayer film having a skin layer (SKL) and a sealing layer (SL) with the specific polymer design according to the present invention (i.e. specific HDPE in skin layer and specific mLLDPE-1 in sealing layer (SL)), leads to an improved overall sealing behaviour, expressed by (SIT+HTT)/HTF being lower than 23, compared to the Comparative Examples having either a different polymer than described for the inventive films in the skin layer (SKL) or in the sealing layer (SL).

1. A multilayered polyethylene film comprising at least a layer (A), being a sealing layer (SL), and a layer (B), being a skin layer (SKL),
wherein the sealing layer (SL) comprises:
i) 30.0 wt % to 100.0 wt %, based on the total weight of the sealing layer (SL), of a first multimodal metallocene catalyzed linear low density polyethylene (mLLDPE-1) having
a density in the range of 905 to 930 kg/m³ (ISO 1183),
a MFR₂ (190° C., 2.16 kg, ISO 1133) in the range of 0.1 to 2.0 g/10 min,
a ratio of the MFR₂₁ (190° C., 21.6 kg, ISO 1133) to MFR₂ (190° C., 2.16 kg, ISO 1133), MFR₂₁/MFR₂, in the range of 22 to 70,
wherein the first multimodal metallocene catalyzed linear low density polyethylene (mLLDPE-1) consists of
(i) 30.0 to 70.0 wt % of a polyethylene component (A), consisting of ethylene polymer fractions (A-1) and (A-2); and
(ii) 70.0 to 30.0 wt % of a polyethylene component (B),
the amount of (A) and (B) adding up to 100.0 wt %, and
ii) 0.0 wt % to 70.0 wt % of an ethylene-1-octene or ethylene-1-butene plastomer having a density in the range of 860 to 910 kg/m³ (ISO 1183), and
a MFR₂ (190° C., 2.16 kg, ISO 1133) in the range of 0.5 to 10.0 g/10 min; and
wherein the skin layer (SKL) comprises:
a) 60.0 wt % to 100.0 wt %, based on the total weight of the skin layer (SKL) of a high density polyethylene (HDPE) having a density in the range of 945 to 970 kg/m³ (ISO 1183).

2. The multilayered polyethylene film according to claim 1, wherein the multilayered film further comprises a layer (C), being a core layer (CL), whereby the core layer (CL) is located between the sealing layer (SL) and the skin layer (SKL), wherein the core layer (CL) comprises:
x) 50.0 wt % to 99.0 wt %, based on the total weight of the core layer (CL), of a multimodal Ziegler-Natta catalyzed linear low density polyethylene (znLLDPE-1) having a density (ISO 1183) in the range of 920 to 950 kg/m³ and an MFR₅ (190° C., 5 kg, ISO 1133) in the range of from 0.1 to 4.0 g/10 min; and
y) 1.0 wt % to 50.0 wt %, based on the total weight of the core layer (CL), of a second multimodal metallocene catalyzed linear low density polyethylene (mLLDPE-2) having
a density in the range of 905 to 930 kg/m³ (ISO 1183) and
a MFR₂ (190° C., 2.16 kg, ISO 1133) in the range of 0.1 to 2.0 g/10 min,
the total amounts of x)+y) summing up to 100 wt %.

3. The multilayered polyethylene film according to claim 1, wherein
polyethylene component (A) of the first multimodal metallocene catalyzed linear low density polyethylene (mLLDPE-1) is an ethylene-1-butene component (A) and
polyethylene component (B) of the first multimodal metallocene catalyzed linear low density polyethylene (mLLDPE-1) is an ethylene-1-hexene component (B),
the amount of (A) and (B) adding up to 100.0 wt %, whereby
the ethylene-1-butene component (A) has
a MFR₂ (190° C., 2.16 kg, ISO 1133) in the range of 2.0 to 400 g/10 min, and/or
a density (ISO 1183) in the range of 920 to 950 kg/m³, and/or
the ethylene-1-hexene component (B) has
a MFR₂ (190° C., 2.16 kg, ISO 1133) in the range of 0.001 to 1.5 g/10 min, and/or
a density (ISO 1183) in the range of 885 to 918 kg/m³.

4. The multilayered polyethylene film according to claim 3, wherein the first multimodal metallocene catalyzed linear low density polyethylene (mLLDPE-1) has a ratio of the MFR₂ (190° C., 2.16 kg, ISO 1133) of the polyethylene component (A), to the MFR₂ (190° C., 2.16 kg, ISO 1133) of the first multimodal metallocene catalyzed linear low density polyethylene (mLLDPE-1) is at least 3.0 to 120.0.

5. The multilayered polyethylene film according to claim 3, wherein the ethylene-1-butene polymer component (A) of the first multimodal metallocene catalyzed linear low density polyethylene (mLLDPE-1) consists of ethylene polymer fractions (A-1) and (A-2), whereby
the ethylene polymer fraction (A-1) has
a MFR₂ (190° C., 2.16 kg, ISO 1133) in the range of 1.0 to 800.0 g/10 min, and/or
a density (ISO 1183) in the range of 920 to 950 kg/m³, and/or
the ethylene polymer fraction (A-2) has
a MFR₂ (190° C., 2.16 kg, ISO 1133) in the range of 2.0 to 400.0 g/10 min, and/or
a density (ISO 1183) in the range of 920 to 950 kg/m³.

6. The multilayered polyethylene film according to claim 1, wherein the high density polyethylene (HDPE) has
a MFR₂ (190° C., 2.16 kg, ISO 1133) in the range of 0.1 to 3.0, and/or
a MFR₅ (190° C., 5 kg, ISO 1133) in the range of 1.0 to 10.0 g/10 min, and/or
a MFR₂₁ (190° C., 21.6 kg, ISO 1133) in the range of 20.0 to 100.0 g/10 min, and/or
a (melt) flow rate ratio FRR21/5 (MFR₂₁/MFR₅) of from 5 to 30.

7. The multilayered polyethylene film according to claim 1, wherein the high density polyethylene (HDPE) is a trimodal HDPE, which is produced in the presence of a metallocene or Ziegler-Natta catalyst system, and consists of a polyethylene component (D) and a polyethylene component (E), whereby
the polyethylene component (D) is an ethylene copolymer, which has
a MFR₂ (190° C., 2.16 kg, ISO 1133) in the range of 10 to 400 g/10 min, and
a density (ISO 1183) in the range of 955 to 970 kg/m³,
the polyethylene component (E) is an ethylene homopolymer or an ethylene copolymer, which has
a MFR₂ (190° C., 2.16 kg, ISO 1133) in the range of 0.01 to 1.0 g/10 min, and
a density (ISO 1183) in the range of 925 to 965 kg/m³.

8. The multilayered polyethylene film according to claim 1, wherein the high density polyethylene (HDPE) is a bimodal HDPE, which is produced in the presence of a metallocene or Ziegler-Natta catalyst system, and consists of a lower molecular weight (LMW) polyethylene component (D) and a higher molecular weight (HMW) polyethylene component (E), wherein the lower molecular weight (LMW) polyethylene component (D) is an ethylene homopolymer having a density (ISO 1183) of from 965 to 975 kg/m³ and the higher molecular weight (HMW) polyethylene component (E) is an ethylene copolymer of ethylene with at least one C4 to C12 alpha-olefin, having a density (ISO 1183) of from 935 to 955 kg/m³.

9. The multilayered polyethylene film according claim 2, wherein the multimodal Ziegler-Natta catalyzed linear low density polyethylene (znLLDPE-1) has
a density (ISO 1183) in the range of 925 to 945 kg/m³, and
a MFR₅ (190° C., 5 kg, ISO 1133) in the range of 0.5 to 3.5 g/10 min,
and which comprises
(X-1) a lower molecular weight (LMW) homopolymer of ethylene and
(X-2) a higher molecular weight (HMW) terpolymer of ethylene, 1-butene and 1-hexene.

10. The multilayered polyethylene film according to claim 2, wherein the multimodal metallocene catalyzed linear low density polyethylene (mLLDPE-2) consists of
(i) 30.0 to 70.0 wt % of a polyethylene component (Y) and
(ii) 70.0 to 30.0 wt % of a polyethylene component (Z), whereby
the amount of (Y) and (Z) add up to 100.0 wt %, and wherein
the ethylene polymer component (Y) has
a MFR₂ (190° C., 2.16 kg, ISO 1133) in the range of 10.0 to 400 g/10 min, and
a density in the range of 930 to 960 kg/m³; and wherein
the ethylene polymer component (Z) has
a MFR₂ (190° C., 2.16 kg, ISO 1133) in the range of 0.0001 to 1.0 g/10 min and
a density in the range of 885 to 910 kg/m³; and/or
wherein the ratio of the MFR₂ (190° C., 2.16 kg, ISO 1133) of the polyethylene component (Y) to the MFR₂ (190° C., 2.16 kg, ISO 1133) of the second multimodal metallocene catalyzed linear low density polyethylene (mLLDPE-2) is at least 100 to 600.

11. The multilayered polyethylene film according to claim 1, wherein the film has a hot tack force (maximum Hot tack force) of at least 5.8 N or more, when measured according to ASTM F 1921-98 (2004), method B on a three-layered blown film sample (60 μm thickness).

12. The multilayered polyethylene film according to claim 1, having at least
a) a hot tack force (maximum Hot tack force (HTF)), when measured according to ASTM F 1921-98 (2004), method B on a three-layered blown film sample (60 μm thickness) in the range of 5.8 N up to 15.0 N, and
b) a hot tack temperature (HTT) of less than 90° C., when measured according to ASTM F 1921-98, method B on a three-layered blown film sample (60 μm thickness), and
c) a haze measured according to ASTM D1003 on a 60 μm 3-layered test blown film in the range of 5 to 48%.

13. The multilayered polyethylene film according to claim 1, wherein the film fulfils inequation (I)
(SIT+HTT)/HTF<23
whereby
SIT is the sealing initiation temperature determined as described in the experimental part on a 3-layered blown film with a thickness of 60 μm,
HTT is the hot tack temperature measured according to ASTM F 1921-98 method B on a three-layered test blown film sample with a thickness of 60 μm and
HTF is the hot tack force, when measured according to ASTM F 1921-98 (2004), method B on a three-layered test blown film sample with a thickness of 60 μm.

14. The multilayered polyethylene film according to claim 1, characterized in that:
the skin layer (SKL) of the multilayered film has a thickness in the range of 1 to 100 μm; and/or
the sealing layer (SL) of the multilayered film has a thickness in the range of 1 to 50 μm; and/or
the multilayered film has a thickness in the range of 12 to 350 μm.

15. A method of use of the film according to claim 1, as packing material, in particular as a packing material for food and/or medical products.

16. The multilayered polyethylene film according to claim 7, wherein polyethylene component (D) consists of a first ethylene copolymer fraction (D-1) and a second ethylene copolymer fraction (D-2).

17. The multilayered polyethylene film according to claim 16, wherein the ethylene polymer fraction (D-1) and/or ethylene polymer fraction (D-2) has:
a MFR₂ (190° C., 2.16 kg, ISO 1133) in the range of 10.0 to 80.0 g/10 min, and
a density (ISO 1183) in the range of 945 to 975 kg/m³.

18. The multilayered polyethylene film according to claim 17, wherein
the MFR₂ of fraction (D-1) is higher than the MFR₂ of fraction (D-2), and/or
the density of fraction (D-2) is higher than the density of fraction (D-1).

19. The multilayered polyethylene film of claim 10, wherein the polyethylene component (Y) consists of ethylene polymer fractions (Y-1) and (Y-2).

20. The multilayered polyethylene film of claim 2, wherein:
the skin layer (SKL) of the multilayered film has a thickness in the range of 1 to 100 μm; and/or
the core layer (CL) of the multilayered film has a thickness in the range of 10 to 200 μm; and/or
the sealing layer (SL) of the multilayered film has a thickness in the range of 1 to 50 μm; and/or
the multilayered film has a thickness in the range of 12 to 350 μm.
